(19) United States
(12) Patent Application Publication
(10) Pub. No.: US 2019/0204868 A1
(43) Pub. Date: Jul. 4, 2019

(54) ELECTRONIC DEVICE AND CONTROL METHOD THEREFOR

(71) Applicant: Samsung Electronics Co., Ltd., Gyeonggi-do (KR)

(72) Inventors: Bo-Kun CHOI, Seoul (KR); Yong-Joon JEON, Gyeonggi-do (KR); Geon-Soo KIM, Gyeonggi-do (KR)

(21) Appl. No.: 16/330,286

(22) PCT Filed: Aug. 25, 2017
(86) PCT No.: PCT/KR2017/009314

§ 371 Date: Mar. 4, 2019

(30) Foreign Application Priority Data
Sep. 5, 2016 (KR) 10-2016-0113994

(51) Int. Cl. G06F 1/16; G06F 3/041; G06F 3/0481; H04M 1/725

(52) U.S. Cl. CPC G06F 1/1626; G06F 3/0412; G06F 1/163; H04M 1/725; G06F 3/0481

(57) ABSTRACT

An electronic device according to various embodiments comprises: a touch screen display; a pressure sensor configured to detect pressure on the touch screen display; a wireless communication circuit configured to transmit and receive a wireless signal; at least one processor electrically connected to the touch screen display, the pressure sensor, and the wireless communication circuit; and a memory electrically connected to the processor, wherein the memory may store instructions which cause the processor, when executed, to: display, on the touch screen display, at least one answer message for a message received via the wireless communication circuit; receive at least one input via the touch screen display; and change the at least one answer message on the basis of at least one of an intensity or a duration of pressure of the received input. Other embodiments are possible.

### TECHNICAL FIELD

The disclosure generally relates to an electronic device that controls the electronic device using a pressure input by a user, and a control method therefor.

### BACKGROUND ART

As electronics have developed, various types of electronic products also have been developed and utilized. Particularly, portable electronic devices including various functions, such as smart phones, tablet PCs, or the like, are have been largely propagated. Also, recently, wearable devices such as a smart watch, smart glasses, and the like have become popular, and users use the wearable devices as assistant devices of a smart phone, a tablet PC, and the like and extend the functions of the wearable devices.

### DETAILED DESCRIPTION OF THE INVENTION

### Technical Problem

A wearable device has a display which is limited in size due to a feature of a small device, and since the size of the display is limited, a user may have difficulty in providing an input to operate the wearable device. For example, a user may easily check a message received by a smart phone using a smart watch, but it is difficult to write a reply to the received message via the smart watch since the display of the smart watch and an input device are limited in size.

Various embodiments of the disclosure may provide an electronic device and a control method therefor, which can provide a means by which a user to easily, quickly and accurately write a response message to a received message via the electronic device.

Various embodiments of the disclosure may provide an electronic device and a control method therefor, which enable a user to easily and simply express a response to a received message by actively utilizing visual emotional content via the electronic device.

Various embodiments of the disclosure may provide an electronic device and a control method therefor, which enable a user to use a touch input and a pressure input together, and provides an intuitive user interface (UI)/user experience (UX) corresponding to an operational feature, such that usability of the electronic device is improved.

### Technical Solution

An electronic device according to various embodiments may include: a touch screen display; a pressure sensor configured to detect a pressure on the touch screen display; a wireless communication circuit configured to transmit and receive a radio signal; at least one processor electrically connected to the touch screen display, the pressure sensor, and the wireless communication circuit; and a memory electrically connected to the processor, wherein the memory stores instructions, and when the instructions are executed, the instructions enable the processor to perform: displaying, on the touch screen display, at least one response message to a message received via the wireless communication circuit; receiving at least one input via the touch screen display; and changing the at least one response message based on at least one of a pressure strength or a duration of the received input.

A control method of an electronic device according to various embodiments may: receiving a message; displaying at least one response message to the received message on a touch screen display of the electronic device; receiving at least one input via the touch screen display; and changing the at least one response message based on at least one of a pressure strength or a duration of the received input.

### Advantageous Effects

An electronic device and a control method according to various embodiments enable a user to easily, quickly, and accurately write a response message to a received message via the electronic device. For example, a user may check a received message via a wearable device having a display limited in size, and may also easily and quickly send a simple response message to an electronic device of a sender of the message. The user may quickly and accurately generate a reply including user intention using a minimum number of touches and pressure inputs.

### BRIEF DESCRIPTION OF DRAWINGS

FIG. 1 illustrates a network environment including an electronic device according to various embodiments;

FIG. 2 is a block diagram of an electronic device according to various embodiments;

FIG. 3 is a block diagram of a programming module according to various embodiments;

FIG. 4 is a block diagram of the configuration of an electronic device according to various embodiments;

FIGS. 5A and 5B are diagrams illustrating the layer structure of elements of an electronic device according to various embodiments;

FIG. 6 is a block diagram illustrating the configuration of an electronic device for generating a recommended response to a received message according to various embodiments;

FIGS. 7A and 7B are flowcharts illustrating a process in which an electronic device selects a scheme of responding to a received message on the basis of a user input according to various embodiments;

FIGS. 8A to 8E are diagrams illustrating screens of an electronic device that operates according to a scheme of responding to a received message selected by a user input according to various embodiments;

FIG. 9 is a flowchart illustrating an operation of executing a recommended response mode by an electronic device according to various embodiments;

FIG. 10 is a diagram illustrating a process in which a user operates an electronic device until transmission of a recommended response to a received message according to various embodiments;

FIG. 11 is a flowchart illustrating a control operation of an electronic device that generates a recommended response to a received message and transmits a response message to a sender according to various embodiments;

FIGS. 12A and 12B are diagrams illustrating displaying of a simplified recommended response message when a simplified recommended response message list is a main keyword list according to various embodiments;

FIGS. 13A to 13F are diagrams illustrating displaying of a simplified recommended response message when a simplified recommended response message list is an emoticon list according to various embodiments;

FIG. 14 is a diagram illustrating an operation of displaying emoticons in the form of animation via combination of keywords of a received message according to various embodiments;

FIGS. 15A to 15D are diagrams illustrating an operation of changing a selected recommended response on the basis of the strength of a pressure input according to various embodiments;

FIGS. 16A to 16C are diagrams illustrating changing a property of text on the basis of a pressure input when a recommended response is text according to various embodiments;

FIGS. 17A to 17D are diagrams illustrating changing the size of an emoticon on the basis of a pressure input when a recommended response is an emoticon according to various embodiments;

FIGS. 18A to 18C are diagrams illustrating changing the size of an emoticon according to the strength of a pressure input to an emoticon selected as a recommended response according to various embodiments;

FIGS. 19A and 19B are diagrams illustrating replacement of a selected emoticon on the basis of an input to the emoticon selected as a recommended response according to various embodiments;

FIGS. 20A to 20D are diagrams illustrating changing a property of an emoticon selected as a recommended response according to various embodiments;

FIGS. 21A to 21D are diagrams illustrating changing a property of an emoticon selected as a recommended response according to various embodiments;

FIGS. 22A to 22D are diagrams illustrating changing a property of an emoticon selected as a recommended response according to various embodiments; and

FIGS. 23A and 23B are flowcharts illustrating a control operation of an electronic device according to various embodiments.

### MODE FOR CARRYING OUT THE INVENTION

Hereinafter, various embodiments of the disclosure will be described with reference to the accompanying drawings. The embodiments and the terms used therein are not intended to limit the technology disclosed herein to specific forms, and should be understood to include various modifications, equivalents, and/or alternatives to the corresponding embodiments. In describing the drawings, similar reference numerals may be used to designate similar constituent elements. A singular expression may include a plural expression unless they are definitely different in a context. As used herein, the expression “A or B” or “at least one of A and/or B” may include all possible combinations of items enumerated together. The expression “a first”, “a second”, “the first”, or “the second” may modify various components regardless of the order and/or the importance, and is used merely to distinguish one element from any other element without limiting the corresponding elements. When an element (e.g., first element) is referred to as being “(functionally or communicatively) connected,” or “directly coupled” to another element (second element), the element may be connected directly to the another element or connected to the another element through yet another element (e.g., third element).

The expression “configured to” as used in various embodiments of the disclosure may be interchangeably used with, for example, “suitable for”, “having the capacity to”, “designed to”, “adapted to”, “made to”, or “capable of” in terms of hardware or software, according to circumstances. Alternatively, in some situations, the expression “device configured to” may mean that the device, together with other devices or components, “is able to”. For example, the phrase “processor adapted (or configured) to perform A, B, and C” may mean a dedicated processor (e.g., embedded processor) only for performing the corresponding operations or a generic-purpose processor (e.g., Central Processing Unit (CPU) or Application Processor (AP)) that can perform the corresponding operations by executing one or more software programs stored in a memory device.

An electronic device according to various embodiments of the disclosure may include at least one of, for example, a smart phone, a tablet Personal Computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various embodiments, the wearable device may include at least one of an accessory type (e.g., a watch, a ring, a bracelet, an anklet, a necklace, a glasses, a contact lens, or a Head-Mounted Device (HMD)), a fabric or clothing integrated type (e.g., an electronic clothing), a body-mounted type (e.g., a skin pad, or tattoo), and a bio-implantable type (e.g., an implantable circuit). In some embodiments, the electronic device may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, Apple TV™, or Google TV™), a game console (e.g., Xbox™ and Play Station™), an electronic dictionary, an electronic key, a camcorder, and an electronic photo frame.

In other embodiments, the electronic device may include at least one of various medical devices (e.g., various portable medical measuring devices (a blood glucose monitoring device, a heart rate monitoring device, a blood pressure measuring device, a body temperature measuring device, etc.), a Magnetic Resonance Angiography (MRA), a Magnetic Resonance Imaging (MRI), a Computed Tomography (CT) machine, and an ultrasonic machine), a navigation device, a Global Positioning System (GPS) receiver, an Event Data Recorder (EDR), a Flight Data Recorder (FDR), a Vehicle Infotainment Devices, an electronic devices for a ship (e.g., a navigation device for a ship, and a gyro-compass), avionics, security devices, an automotive head unit, a robot for home or industry, an Automatic Teller's Machine (ATM) in banks, Point Of Sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.). According to some embodiments, an electronic device may include at least one of a part of furniture or a building/structure, an electronic board, an electronic signature receiving device, a projector, and various types of measuring instruments (e.g., a water meter, an electric meter, a gas meter, a radio wave meter, and the like). In various embodiments, the electronic device may be flexible, or may be a combination of one or more of the aforementioned various devices. The electronic device according to one embodiment of the disclosure is not limited to the above described devices. In the disclosure, the term “user” may indicate a person using an electronic device or a device (e.g., an artificial intelligence electronic device) using an electronic device.

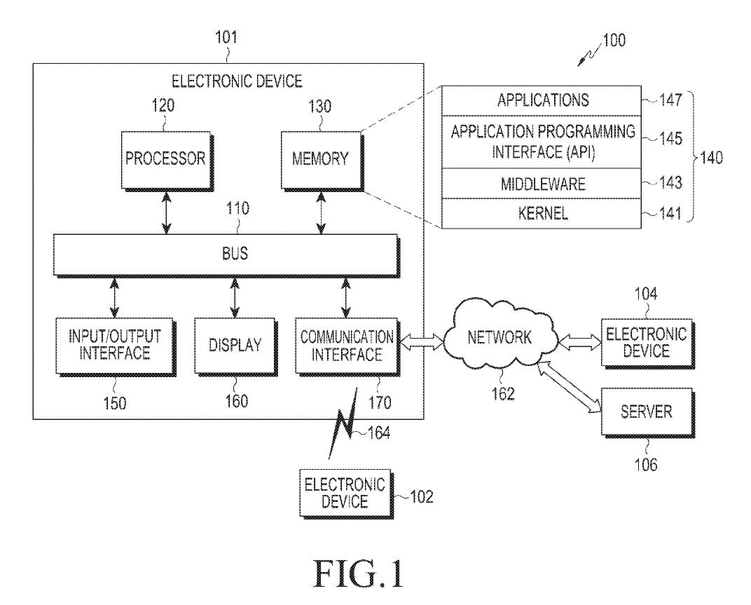

An electronic device 101 in a network environment 100 according to various embodiments will be described with reference to FIG. 1. The electronic device 101 may include a bus 110, a processor 120, a memory 130, an input/output interface 150, a display 160, and a communication interface 170. In some embodiments, the electronic device 101 may omit at least one of the elements, or may further include other elements. The bus 110 may include, for example, a circuit that interconnects the elements 110 to 170 and transmits communication (for example, control messages or data) between the elements. The processor 120 may include one or more of a central processing unit, an application processor, and a Communication Processor (CP). The processor 120, for example, may carry out operations or data processing relating to the control and/or communication of at least one other element of the electronic device 101.

The memory 130 may include volatile and/or non-volatile memory. The memory 130 may store, for example, instructions or data relevant to at least one other element of the electronic device 101. According to an embodiment, the memory 130 may store software and/or a program 140. The program 140 may include a kernel 141, middleware 143, an Application Programming Interface (API) 145, and/or application programs (or “applications”) 147. At least some of the kernel 141, the middleware 143, and the API 145 may be referred to as an operating system. The kernel 141 may control or manage system resources (for example, the bus 110, the processor 120, or the memory 130) used for executing an operation or function implemented by other programs (for example, the middleware 143, the API 145, or the application 147). Furthermore, the kernel 141 may provide an interface through which the middleware 143, the API 145, or the application programs 147 may access the individual elements of the electronic device 101 to control or manage the system resources.

The middleware 143 may function as, for example, an intermediary for allowing the API 145 or the application programs 147 to communicate with the kernel 141 to exchange data. Furthermore, the middleware 143 may process one or more task requests, which are received from the application programs 147, according to priorities thereof. For example, the middleware 143 may assign priorities for using the system resources (for example, the bus 110, the processor 120, the memory 130, or the like) of the electronic device 101 to one or more of the application programs 147, and may process the one or more task requests. The API 145 is an interface through which the applications 147 control functions provided from the kernel 141 or the middleware 143, and may include, for example, at least one interface or function (for example, instruction) for file control, window control, image processing, or text control. For example, the input/output interface 150 may forward instructions or data, input from a user or an external device, to the other element(s) of the electronic device 101, or may output instructions or data, received from the other element(s) of the electronic device 101, to the user or the external device.

The display 160 may include, for example, a Liquid Crystal Display (LCD), a Light Emitting Diode (LED) display, an Organic Light Emitting Diode (OLED) display, a Micro Electro Mechanical System (MEMS) display, or an electronic paper display. The display 160 may display, for example, various types of content (for example, text, images, videos, icons, and/or symbols) for a user. The display 160 may include a touch screen and may receive, for example, a touch, gesture, proximity, or hovering input using an electronic pen or the user's body part. The communication interface 170 may establish, for example, communication between the electronic device 101 and an external device (for example, a first external electronic device 102, a second external electronic device 104, or a server 106). For example, the communication interface 170 may be connected to a network 162 through wireless or wired communication to communicate with the external device (for example, the second external electronic device 104 or the server 106).

The wireless communication may include, for example, a cellular communication that uses at least one of LTE, LTE-Advance (LTE-A), code division multiple access (CDMA), wideband CDMA (WCDMA), universal mobile telecommunications system (UMTS), wireless broadband (WiBro), global system for mobile communications (GSM), or the like. According to an embodiment, the wireless communication may include, for example, at least one of Wi-Fi (Wireless Fidelity), Bluetooth, Bluetooth low energy (BLE), ZigBee, near field communication (NFC), magnetic secure transmission, Radio Frequency (RF), and body area network (BAN). According to an embodiment, the wireless communication may include GNSS. The GNSS may be, for example, a global positioning system (GPS), a global navigation satellite system (Glonass), a Beidou navigation satellite system (hereinafter, referred to as “Beidou”), or Galileo (the European global satellite-based navigation system). Hereinafter, in this document, the term “GPS” may be interchangeable with the term “GNSS”. The wired communication may include, for example, at least one of a Universal Serial Bus (USB), a High Definition Multimedia Interface (HDMI), Recommended Standard 232 (RS-232), power line communication, a Plain Old Telephone Service (POTS), and the like. The network 162 may include a telecommunications network, for example, at least one of a computer network (for example, a LAN or a WAN), the Internet, and a telephone network.

Each of the first and second external electronic devices 102 and 104 may be of the same or a different type from the electronic device 101. According to various embodiments, all or some of the operations performed in the electronic device 101 may be performed in another electronic device or a plurality of electronic devices (for example, the electronic devices 102 and 104, or the server 106). According to an embodiment, when the electronic device 101 has to perform a function or service automatically or in response to a request, the electronic device 101 may request another device (for example, the electronic device 102 or 104, or the server 106) to perform at least some functions relating thereto, instead of autonomously or additionally performing the function or service. Another electronic device (for example, the electronic device 102 or 104, or the server 106) may execute the requested functions or the additional functions, and may deliver a result thereof to the electronic device 101. The electronic device 101 may provide the received result as it is, or may additionally process the received result to provide the requested functions or services. To this end, for example, cloud computing, distributed computing, or client-server computing technology may be used.

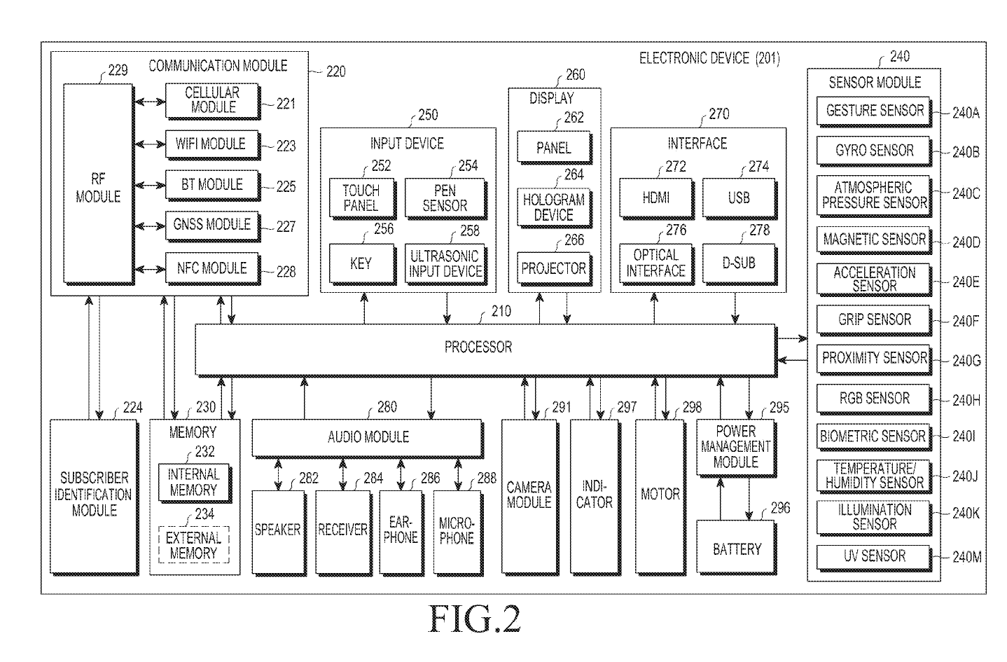

FIG. 2 is a block diagram illustrating an electronic device 201 according to various embodiments. The electronic device 201 may include, for example, the whole or part of the electronic device 101 illustrated in FIG. 1. The electronic device 201 may include at least one processor 210 (for example, an AP), a communication module 220, a subscriber identification module 224, a memory 230, a sensor module 240, an input device 250, a display 260, an interface 270, an audio module 280, a camera module 291, a power management module 295, a battery 296, an indicator 297, and a motor 298. The processor 210 may control a plurality of hardware or software elements connected thereto and may perform various data processing and operations by driving an operating system or an application program. The processor 210 may be implemented by, for example, a System on Chip (SoC). According to an embodiment, the processor 210 may further include a Graphic Processing Unit (GPU) and/or an image signal processor. The processor 210 may also include at least some of the elements illustrated in FIG. 2 (for example, a cellular module 221). The processor 210 may load, in volatile memory, instructions or data received from at least one of the other elements (for example, non-volatile memory), process the loaded instructions or data, and store the resultant data in the non-volatile memory.

The communication module 220 may have a configuration that is the same as, or similar to, that of the communication interface 170. The communication module 220 (for example, the communication interface 170) may include, for example, a cellular module 221, a Wi-Fi module 223, a Bluetooth module 225, a GNSS module 227, an NFC module 228, and an RF module 229. The cellular module 221 may provide, for example, a voice call, a video call, a text message service, an Internet service, or the like through a communication network. According to an embodiment of the disclosure, the cellular module 221 may identify or authenticate an electronic device 201 in the communication network using a subscriber identification module (for example, a Subscriber Identity Module (SIM) card) 224. According to an embodiment, the cellular module 221 may perform at least some of the functions that the AP 210 may provide. According to an embodiment, the cellular module 221 may include a communication processor (CP). In some embodiments, at least some (two or more) of the cellular module 221, the Wi-Fi module 223, the Bluetooth module 225, the GNSS module 227, and the NFC module 228 may be included in a single Integrated Chip (IC) or IC package. The RF module 229 may transmit/receive, for example, a communication signal (for example, an RF signal). The RF module 229 may include, for example, a transceiver, a power amp module (PAM), a frequency filter, a low noise amplifier (LNA), an antenna, or the like. According to another embodiment, at least one of the cellular module 221, the Wi-Fi module 223, the BT module 225, the GNSS module 227, and the NFC module 228 may transmit/receive an RF signal through a separate RF module. The subscriber identification module 224 may include, for example, a card that includes a subscriber identity module and/or an embedded SIM, and may contain unique identification information (for example, an Integrated Circuit Card Identifier (ICCID)) or subscriber information (for example, an International Mobile Subscriber Identity (IMSI)).

The memory 230 (for example, the memory 130) may include, for example, an internal memory 232 or an external memory 234. The internal memory 232 may include, for example, at least one of a volatile memory (for example, a DRAM, an SRAM, an SDRAM, or the like) and a non-volatile memory (for example, a One Time Programmable ROM (OTPROM), a PROM, an EPROM, an EEPROM, a mask ROM, a flash ROM, a flash memory, a hard disc drive, or a Solid State Drive (SSD)). The external memory 234 may include a flash drive, for example, a compact flash (CF), a secure digital (SD), a Micro-SD, a Mini-SD, an eXtreme digital (xD), a multi-media card (MMC), a memory stick, and the like. The external memory 234 may be functionally and/or physically connected to the electronic device 201 through various interfaces.

The sensor module 240 may, for example, measure a physical quantity or detect the operating state of the electronic device 201 and may convert the measured or detected information into an electrical signal. The sensor module 240 may include, for example, at least one of a gesture sensor 240A, a gyro sensor 240B, an atmospheric pressure sensor 240C, a magnetic sensor 240D, an acceleration sensor 240E, a grip sensor 240F, a proximity sensor 240G, a color sensor 240H (for example, a red, green, blue (RGB) sensor), a biometric sensor 240I, a temperature/humidity sensor 240J, an illumination sensor 240K, and a ultraviolet (UV) sensor 240M. Additionally or alternatively, the sensor module 240 may include, for example, an e-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 240 may further include a control circuit for controlling one or more sensors included therein. In some embodiments, the electronic device 201 may further include a processor, which is configured to control the sensor module 240, as a part of the processor 210 or separately from the processor 210 in order to control the sensor module 240 while the processor 210 is in a sleep state.

The input device 250 may include, for example, a touch panel 252, a (digital) pen sensor 254, a key 256, or an ultrasonic input device 258. The touch panel 252 may use, for example, at least one of a capacitive type, a resistive type, an infrared type, and an ultrasonic type. Furthermore, the touch panel 252 may further include a control circuit. The touch panel 252 may further include a tactile layer to provide a tactile reaction to a user. The (digital) pen sensor 254 may include, for example, a recognition sheet that is a part of, or separate from, the touch panel. The key 256 may include, for example, a physical button, an optical key, or a keypad. The ultrasonic input device 258 may detect ultrasonic waves, which are generated by an input tool, through a microphone (for example, a microphone 288) to identify data corresponding to the detected ultrasonic waves.

The display 260 (for example, the display 160) may include a panel 262, a hologram device 264, a projector 266, and/or a control circuit for controlling them. The panel 262 may be implemented to be, for example, flexible, transparent, or wearable. The panel 262, together with the touch panel 252, may be configured as one or more modules. According to an embodiment, the panel 262 may include a pressure sensor (or a POS sensor) which may measure a strength of pressure of a user's touch. The pressure sensor may be implemented so as to be integrated with the touch panel 252 or may be implemented as one or more sensors separate from the touch panel 252. The hologram device 264 may show a three dimensional image in the air by using an interference of light. The projector 266 may display an image by projecting light onto a screen. The screen may be located, for example, in the interior of, or on the exterior of, the electronic device 201. The interface 270 may include, for example, an HDMI 272, a USB 274, an optical interface 276, or a D-subminiature (D-sub) 278. The interface 270 may be included in, for example, the communication circuit 170 illustrated in FIG. 1. Additionally or alternatively, the interface 270 may, for example, include a mobile high-definition link (MHL) interface, a secure digital (SD) card/multi-media card (MMC) interface, or an infrared data association (IrDA) standard interface.

The audio module 280 may convert, for example, sound into an electrical signal, and vice versa. At least some elements of the audio module 280 may be included, for example, in the input/output interface 145 illustrated in FIG. 1. The audio module 280 may process sound information that is input or output through, for example, a speaker 282, a receiver 284, earphones 286, the microphone 288, and the like. The camera module 291 is a device that can photograph a still image and a moving image. According to an embodiment, the camera module 291 may include one or more image sensors (for example, a front sensor or a rear sensor), a lens, an image signal processor (ISP), or a flash (for example, an LED or xenon lamp). The power management module 295 may manage, for example, the power of the electronic device 201. According to an embodiment, the power management module 295 may include a power management integrated circuit (PMIC), a charger IC, or a battery or fuel gauge. The PMIC may use a wired and/or wireless charging method. Examples of the wireless charging method may include a magnetic resonance method, a magnetic induction method, an electromagnetic wave method, and the like. Additional circuits (for example, a coil loop, a resonance circuit, a rectifier, and the like) for wireless charging may be further included. The battery gauge may measure, for example, the residual amount of the battery 296 and a voltage, current, or temperature while charging. The battery 296 may include, for example, a rechargeable battery and/or a solar battery.

The indicator 297 may display a particular state, for example, a booting state, a message state, a charging state, or the like of the electronic device 201 or a part (for example, the processor 210) of the electronic device 201. The motor 298 may convert an electrical signal into a mechanical vibration and may generate a vibration, a haptic effect, or the like. The electronic device 201 may include a mobile TV support device that can process media data according to a standard, such as digital multimedia broadcasting (DMB), digital video broadcasting (DVB), mediaFlo™, and the like. Each of the above-described component elements of hardware according to the disclosure may be configured with one or more components, and the names of the corresponding component elements may vary based on the type of electronic device. According to various embodiments, the electronic device (for example, the electronic device 201) may not include some elements, or may further include additional elements. Some elements may be coupled to constitute one object, but the electronic device may perform the same functions as those of the corresponding elements before being coupled to each other.

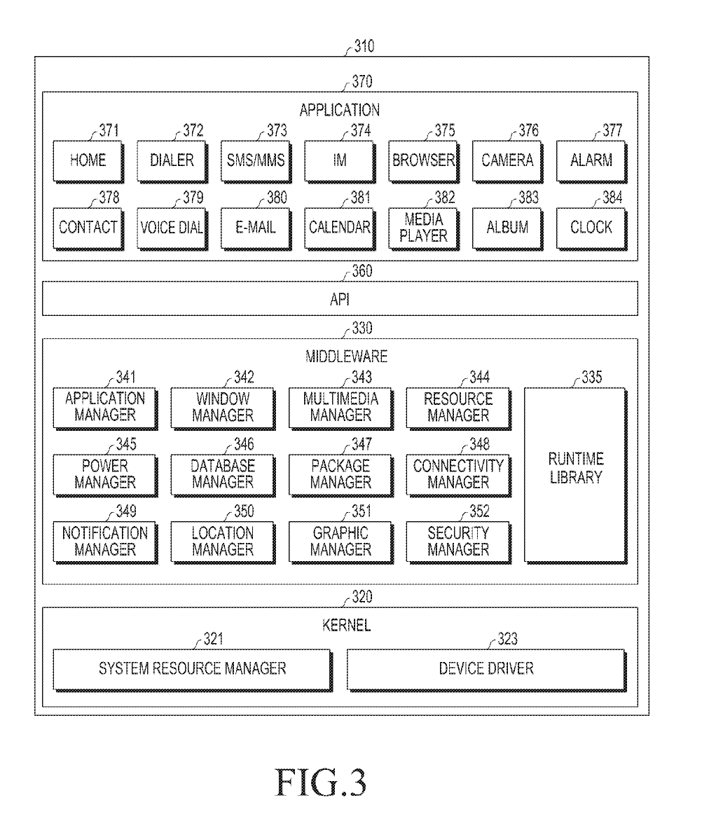

FIG. 3 is a block diagram of a program module according to various embodiments. According to an embodiment, the program module 310 (for example, the program 140) may include an Operating System (OS) that controls resources relating to an electronic device (for example, the electronic device 101) and/or various applications (for example, the application programs 147) that are driven on the operating system. The operating system may include, for example, Android™, iOS™, Windows™, Symbian™, Tizen™, or Bada™. Referring to FIG. 3, the program module 310 may include a kernel 320 (for example, the kernel 141), middleware 330 (for example, the middleware 143), an API 360 (for example, the API 145), and/or applications 370 (for example, the application programs 147). At least a part of the program module 310 may be preloaded on the electronic device, or may be downloaded from an external electronic device (for example, the electronic device 102 or 104 or the server 106).

The kernel 320 may include, for example, a system resource manager 321 and/or a device driver 323. The system resource manager 321 may control, allocate, or retrieve system resources. According to an embodiment, the system resource manager 321 may include a process manager, a memory manager, or a file system manager. The device driver 323 may include, for example, a display driver, a camera driver, a Bluetooth driver, a shared memory driver, a USB driver, a keypad driver, a Wi-Fi driver, an audio driver, or an inter-process communication (IPC) driver. The middleware 330 may provide, for example, a function required by the applications 370 in common, or may provide various functions to the applications 370 through the API 360 such that the applications 370 can efficiently use limited system resources within the electronic device. According to an embodiment, the middleware 330 may include at least one of a runtime library 335, an application manager 341, a window manager 342, a multi-media manager 343, a resource manager 344, a power manager 345, a database manager 346, a package manager 347, a connectivity manager 348, a notification manager 349, a location manager 350, a graphic manager 351, and a security manager 352.

The runtime library 335 may include, for example, a library module that a compiler uses in order to add a new function through a programming language while the applications 370 are being executed. The runtime library 335 may manage an input/output, manage a memory, or process an arithmetic function. The application manager 341 may manage, for example, the life cycles of the applications 370. The window manager 342 may manage GUI resources used for a screen. The multimedia manager 343 may identify formats required for reproducing various media files and may encode or decode a media file using a codec suitable for the corresponding format. The resource manager 344 may manage the source code of the applications 370 or the space in memory. The power manager 345 may manage, for example, the capacity or power of a battery and may provide power information required for operating the electronic device. According to an embodiment, the power manager 345 may operate in conjunction with a Basic Input/Output System (BIOS). The database manager 346 may, for example, generate, search, or change databases to be used by the applications 370. The package manager 347 may manage the installation or update of an application that is distributed in the form of a package file.

The connectivity manager 348 may manage, for example, a wireless connection. The notification manager 349 may provide information on an event (for example, an arrival message, an appointment, a proximity notification, or the like) to a user. The location manager 350 may manage, for example, the location information of the electronic device. The graphic manager 351 may manage a graphic effect to be provided to a user and a user interface relating to the graphic effect. The security manager 352 may provide, for example, system security or user authentication. According to an embodiment, the middleware 330 may include a telephony manager for managing a voice or video call function of the electronic device or a middleware module that is capable of forming a combination of the functions of the above-described elements. According to an embodiment, the middleware 330 may provide an operating-system-specific module. Furthermore, the middleware 330 may dynamically remove some of the existing elements, or may add new elements. The API 360 is, for example, a set of API programming functions, and may be provided with different configurations depending on the operating system. For example, in the case of Android or iOS, one API set may be provided for each platform, and in the case of Tizen, two or more API sets may be provided for each platform.

The applications 370 (e.g., the applications 147A) may include, for example, one or more applications that can perform functions, such as home 371, dialer 372, SMS/MMS 373, Instant Message (IM) 374, browser 375, camera 376, alarm 377, contacts 378, voice dial 379, e-mail 380, calendar 381, media player 382, album 383, clock 384, health care (e.g., measuring exercise quantity or blood sugar), providing environment information (e.g., providing atmospheric pressure, humidity, temperature information, etc), and the like. According to an embodiment, the applications 370 may include an information exchange application that can support the exchange of information between the electronic device and an external electronic device. The information exchange application may include, for example, a notification relay application for relaying particular information to an external electronic device or a device management application for managing an external electronic device. For example, the notification relay application may relay notification information generated in the other applications of the electronic device to an external electronic device, or may receive notification information from an external electronic device to provide the received notification information to a user. The device management application may perform a function (for example, a function of turning on/off an external electronic device (or some elements thereof) or controlling brightness (or resolution) of the display) of the external electronic device communicating with the electronic device or install, delete, or update an application executed by the external electronic device. According to an embodiment, the applications 370 may include applications (for example, a health care application of a mobile medical appliance) that are designated according to the attributes of an external electronic device. According to an embodiment, the applications 370 may include applications received from an external electronic device. At least some of the program module 310 may be implemented (for example, executed) by software, firmware, hardware (for example, the processor 210), or a combination of two or more thereof and may include a module, a program, a routine, an instruction set, or a process for performing one or more functions.

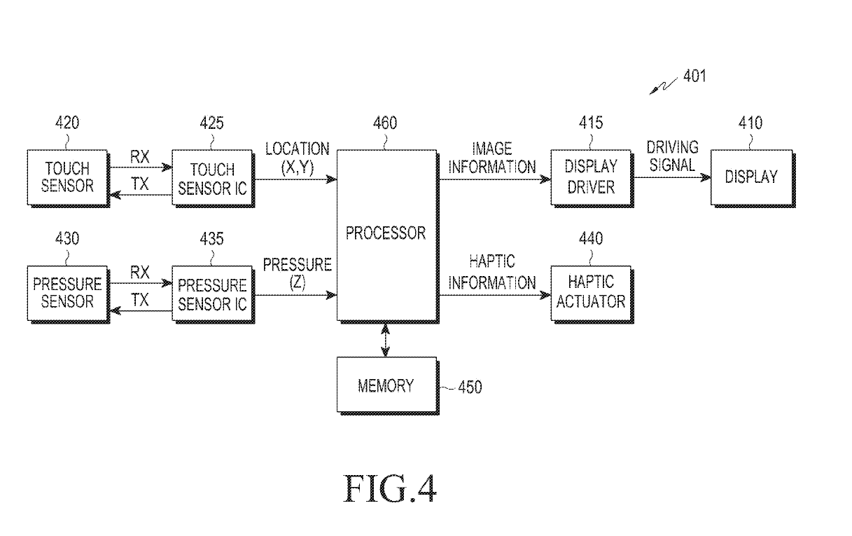

FIG. 4 is a block diagram of the configuration of an electronic device according to various embodiments.

Referring to FIG. 4, an electronic device 401 (e.g., the electronic device 101) according to an embodiment may include a display 410 (e.g., the display 160), a display driving circuit (display driving IC (DDI)) 415, a touch sensor 420, a touch sensor IC 425, a pressure sensor 430, a pressure sensor IC 435, a haptic actuator 440, a memory 450 (e.g., the memory 130), and a processor 460 (e.g., the processor 120). Descriptions of the configuration which have been provided with reference to FIGS. 1 to 3 will be omitted.

The display 410 may receive an image driving signal supplied from the display driving circuit (DDI) 415. The display 410 may display various contents and/or items (e.g., text, images (objects), videos, icons, functional objects, symbols or the like) on the basis of the image driving signal. In the disclosure, the display 410 may be coupled with the touch sensor 420 and/or the pressure sensor 430 to overlap each other, and may be referred to as a “display panel”. The display 410 may operate in a low-power mode.

The display driving circuit (DDI) 415 may supply an image driving signal corresponding to image information received from the processor 460 (host) to the display 410 at a predetermined frame rate. The display driving circuit 415 may drive the display 410 in a low-power mode. Although not illustrated, according to an embodiment, the display driving circuit 415 may include a graphic RAM, an interface module, an image processing unit, a multiplexer, a display timing controller (T-con), a source driver, a gate driver, and/or an oscillator.

In the touch sensor 420, a designated physical quantity (e.g., voltage, a quantity of light, resistance, a quantity of electric charge, capacitance, or the like) may change by a touch by a user. According to an embodiment, the touch sensor 420 may be disposed to overlap the display 410.

The touch sensor IC 425 may sense a change in the physical quantity occurring in the touch sensor 420, and may calculate a location (X, Y) where a touch is provided, on the basis of the change in the physical quantity (e.g., voltage, resistance, capacitance, or the like). The calculated location (coordinates) may be provided (or reported) to the processor 460.

For example, when a body part of a user (e.g., a finger), an electronic pen, or the like is in contact with a cover glass of the display, a coupling voltage between a transmission end (Tx) and/or a reception end (Rx) included in the touch sensor 420 may change. For example, a change in the coupling voltage may be sensed by the touch sensor IC 425, and the touch sensor IC 425 may transfer, to the processor 460, coordinates (X, Y) of the location where the touch is provided. The processor 460 may obtain data related to the coordinates (X, Y) as an event associated with a user input.

The touch sensor IC 425 may be also referred to as a touch IC, a touchscreen IC, a touch controller, a touchscreen controller IC, or the like. According to an embodiment, in an electronic device that excludes the touch sensor IC 425, the processor 460 may execute the function of the touch sensor IC 425. According to an embodiment, the touch sensor IC 425 and the processor 460 may be implemented as an integrated configuration (e.g., one-chip).

The pressure sensor 430 may sense pressure (or force) provided by an external object (e.g., a finger or an electronic pen). According to an embodiment, in the pressure sensor 430, a physical quantity (e.g., capacitance) between a transmission end (Tx) (e.g., the first electrode 341 of FIG. 3) and a reception end (Rx) (e.g., a second electrode 342 of FIG. 3) may change by a touch.

The pressure sensor IC 435 may sense a change in physical quantity (e.g., capacitance or the like) occurring in the pressure sensor 430, and may calculate pressure applied by a touch by a user on the basis of the change in the physical quantity. The pressure sensor 430 may identify a change (speed) in the strength of pressure that varies during a unit time, a direction in which pressure is given, the strength of pressure, and the like. The pressure or the strength, speed, direction, or the like of the pressure may be provided to the processor 460, together with the location (X,Y) where a touch is provided.

According to an embodiment, the strength of pressure may be referred to as the intensity or level of pressure. Regarding the strength of pressure, the strength of pressure within a predetermined range may be designated as a predetermined level. For example, if the strength of pressure ranges from 1 to 3, the level of pressure may be designated as level 1.

According to an embodiment, the pressure sensor IC 435 may be also referred to as a force touch controller, a force sensor IC, a pressure panel IC, or the like. The pressure sensor IC 435 and the touch sensor IC 425 may be embodied as an integrated configuration (e.g., one-chip).

The haptic actuator 440 may provide a tactual feedback (e.g., vibration) to a user according to a control command from the processor 460. For example, the haptic actuator 440 may provide a tactual feedback to a user when a touch input (e.g., a touch, a hovering touch, or a force touch) is received from the user.

The memory 450 may store commands or data associated with operations of elements included in the electronic device 401. For example, the memory 450 may store at least one application program including a user interface configured to display a plurality of items on a display. For example, the memory 450 may store instructions which enable the processor 460 to perform various operations written in the present document when the instructions are executed.

For example, the processor 460 may be electrically connected to elements 410 to 450 included in the electronic device 410, and may perform an operation or data processing related to control and/or communication of the elements 410 to 450 included in the electronic device 401.

According to an embodiment, the processor 460 may execute (launch) application programs (or simply “applications”) displaying a user interface on the display 410. The processor 460 may display an array of a plurality of items on a user interface displayed on the display 410 in response to the execution of an application.

The processor 460 may receive first data (data including touch location coordinates (X, Y)) generated from the touch sensor 420. The processor 460 may receive second data (data including touch pressure (Z)) generated from the pressure sensor 430.

According to an embodiment, the processor 460 may activate at least a part of the pressure sensor 430 while the display 410 is deactivated. The processor 460 may at least partially activate the pressure sensor 430 while the display 410 is deactivated. For example, the processor 460 may activate the whole or a part of the pressure sensor 430 when the electronic device 401 is in an awake-state or in an idle state in which elements such as the display 410 or the like are deactivated. The processor 460 may deactivate at least a part of the touch sensor 420 while the display 410 is deactivated or the electronic device 401 is in the idle state, in order to reduce the amount of power consumed during the idle state, and to decrease malfunction by a touch.

According to an embodiment, if a designated condition is satisfied while the display 410 is deactivated, the processor 460 may activate at least a part of the pressure sensor 430. For example, the processor 460 may activate the pressure sensor 430 a predetermined period of time after the display 410 is deactivated, or until a predetermined period of time after the display 410 is deactivated. As another example, the processor 460 may activate the pressure sensor 430 when the usage by a user is sensed by a gyro sensor, a proximity sensor, or the like. As another example, when temperature is lower than a designated value during a designated time interval, when touch is sensed via a touch panel, when the electronic device 401 is close to an external device, or when a stylus contained in the electronic device 401 is taken off from the electronic device 401, the processor 460 may activate the pressure sensor 430. As another example, the processor 460 may activate the pressure sensor 430 while an application (e.g., a music player) that operates during an idle state operates.

According to an embodiment, the processor 460 may deactivate at least a part of the pressure sensor 430 if a designated condition is satisfied while the display 410 is deactivated. For example, when it is recognized that the electronic device 401 is put in a pouch or a bag or is put face down, using a proximity sensor, an illumination sensor, an acceleration sensor, and/or a gyro sensor, or the like, the processor 460 may deactivate the pressure sensor 430. As another example, when the electronic device 410 is connected to an external device (e.g., being connected to a desk top), the processor 460 may deactivate the pressure sensor 430.

According to an embodiment, the processor 460 may activate only a designated part of the pressure sensor 430 while the display 410 is deactivated. For example, the processor 460 may activate a designated part of the pressure sensor 430 (e.g., a central lower part of the pressure sensor 430) in order to decrease the amount of power consumed during the idle state. When the pressure sensor 430 includes a set of two or more sensors, the processor 460 may activate some of the two or more sensors.

According to an embodiment, by activating the pressure sensor 430, the processor 460 may sense pressure using the pressure sensor 430 while the electronic device 401 is in the idle state. For example, the processor 460 may receive data related to pressure applied to the display 410 by an external object, from the pressure sensor 430 while the display 410 is deactivated.

According to an embodiment, the processor 460 may determine whether pressure is higher than or equal to a selected level on the basis of the data related to the pressure. When it is determined that the pressure is greater than or equal to the selected level, the processor 460 may perform a function without fully activating the display 410. For example, the processor 460 may perform a function when pressure of which the strength is higher than a designated level is sensed. For example, the processor 460 may activate a part of the display 410. The processor 460 may determine a function to execute on the basis of at least one of the location where pressure is sensed, the strength of pressure, the number of points where pressure is sensed, the speed of pressure, the direction of pressure, and the duration time of pressure.

Although FIG. 4 illustrates that the pressure sensor 430 provides data associated pressure (Z) to a processor, the disclosure is not limited thereto. When the pressure sensor 430 includes a set of two or more sensors, the processor 460 may sense the location where pressure is applied on the basis of the location of a sensor of which capacity changes among two or more sensors. For example, when the pressure sensor 430 is implemented as a set of six sensors disposed in a 3×2 array, the processor 460 may determine the location where pressure is applied on the basis of the amount of variation in capacity of each of the six sensors and the location where each of the six sensors is disposed. The processor 460 may determine the location where pressure is applied without using the touch sensor 430. When pressure is sensed by the pressure sensor 430, the processor 460 activates the touch sensor 420, and may detect the location where the pressure is applied using the touch sensor.

According to an embodiment, when the pressure sensor 430 senses the pressure of a first level applied by a touch, the processor 460 may perform a first function. The processor 460 may determine the first function on the basis of at least one of the location where the pressure of the first level is sensed, the strength of the pressure, the number of points where the pressure is sensed, the speed of the pressure, the direction of the pressure, and the duration time of the pressure, and may perform the determined first function. The pressure of the first level may indicate the pressure corresponding to the strength within a designated strength range.

According to an embodiment, when an input for a response message to a message received via a wireless communication circuit (not illustrated) (e.g., the communication interface 170) is detected from the display 410 (e.g., a touch screen), the processor 460 may determine an execution mode to generate the response message using at least one of the pressure or the duration of the input, and may perform processing so as to provide a user interface for writing the response message via the display 410 according to the determined execution mode.

According to an embodiment, the processor 460 may display the response message on the display 410 using information related to the response message. When the pressure of an input is detected from the display 410 using the pressure sensor 430, the processor 460 may change at least a part of the response message on the basis of the pressure of the input on the display 410. For example, the response message may include at least one of text, an emoticon, an image, a video, or an avatar. For example, the at least one of the size, color, or form of the response message may be changed.

According to an embodiment, in response to the pressure strength of the input to the response message, the processor 460 may change the color of at least a part of the response message.

According to an embodiment, in response to the pressure strength of the input to the response message, the processor 460 may scale up or down the size of the response message at a designated rate, and may display the scaled response message.

According to an embodiment, the processor 450 may generate one or more recommended response messages to the received message, may extract at least one keyword associated with the recommended response messages, and may determine the keyword to be the response message.

According to an embodiment, the processor 450 may generate one or more recommended response messages to the received message, may extract at least one keyword associated with the recommended response messages, may detect at least one emoticon corresponding to the keyword, and may determine the emoticon to be the response message.

According to an embodiment, when the input is a pressure input, the processor 460 may determine an execution mode for generating the response message according to the strength of the pressure input, such as a first response mode that generates a response message using voice input via a microphone (e.g., the microphone 288) of the electronic device, a second response mode that generates a response message using a video or a picture obtained via a camera (e.g., the camera module 291) of the electronic device, or a third response mode that generates a response message using information related to the received message. Also, when the input is a touch input, the processor 460 may determine the execution mode for generating the response message according to the duration of the touch input, such as a fourth response mode that executes a menu including the first response mode, the second response mode, and the third response mode, or a fourth response mode that generates a response message using text input via a virtual keypad.

By executing another function associated with the currently executed function according to the strength of the pressure applied to the electronic device 401 after a touch is given to the electronic device 401, convenience of input may be improved.

The above-described operation of the processor 460 is merely an example, and the disclosure is not limited thereto. For example, the operation of a processor described in another part of the disclosure may be understood as the operation of the processor 460. In the disclosure, at least a part of the operation described as the operation of an “electronic device” may be understood as the operation of the processor 460.

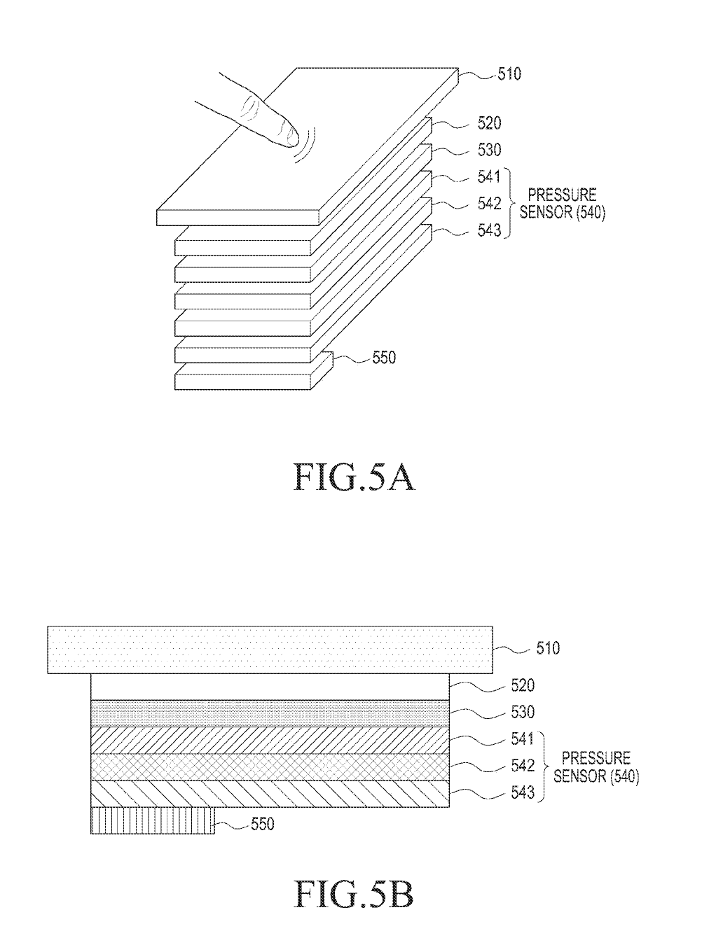

FIGS. 5A and 5B are diagrams illustrating the layer structure of elements of an electronic device (e.g., the electronic device 101) according to various embodiments.

The layer structures of FIGS. 5A and 5B may be applicable to the display 110 of FIG. 1. The configurations of FIGS. 5A and 5B may be disposed between the front side (a first side) and the back side (a second side) of the electronic device 101 of FIG. 1.

According to an embodiment, in the layer structure of a display, a cover glass 510 may transmit light obtained via a display panel 530. When a body part of a user (e.g., a finger) is in contact with the cover glass 510, the user may give a “touch” (including a contact using an electronic pen). The cover glass 510 may be formed of, for example, tempered glass, reinforced plastic, flexible polymeric material, or the like and may protect a display and an electronic device including the display from external shocks. According to an embodiment, the cover glass 510 may be referred to as a glass window or a cover window.

In the touch sensor 520, various physical quantities (e.g., voltage, a quantity of light, resistance, a quantity of electric charge, capacitance, or the like) may change by a touch by an external object (e.g., a finger of a user or an electronic pen). The touch sensor 520 may detect at least one location on the display (e.g., on the surface of the cover glass 510) where a touch is given by an external object, on the basis of a change in a physical quantity. For example, the touch sensor 520 may include a capacitive touch sensor, a resistive touch sensor, an infrared touch sensor, a resistive-type touch sensor, piezo touch sensor, or the like. An electrode of the touch sensor 520 may be contained inside the display 530. According to an embodiment, the touch sensor 520 may be called by various names, such as a touch panel, a touch screen panel, or the like, depending on an implementation scheme.

The display 530 may output at least one content or item (e.g., text, an image, a video, an icon, a widget, a symbol, or the like). The display 530 may include, for example, a liquid crystal display (LCD) panel, a light emitting diode (LED) display panel, an organic light emitting diode (OLED) display panel, a micro electro mechanical system (MEMS) display panel, or an electronic paper display panel.

According to an embodiment, the display 530 may be implemented to be integrated with a touch sensor (or a touch panel) 520. In this instance, the display 530 may be referred to as a touch screen panel (TSP) or a touch screen display panel.

The pressure sensor 540 may detect pressure (or force) which is applied by an external object (e.g., a finger of a user or an electronic pen) to the display (e.g., the surface of the cover glass 510). According to an embodiment, the pressure sensor 540 may include a first electrode 541, a second electrode 542, and a dielectric layer 543. For example, the pressure sensor 540 may detect the pressure of a touch on the basis of capacitance which is between the first electrode 541 and the second electrode 542 and changes by the pressure of the touch.

The dielectric layer 543 of the pressure sensor 540 may include materials, such as silicone, air, foam, membrane, OCA, sponge, rubber, ink, polymer (PC, PTE, etc.), or the like. The materials of the first electrode 541 and/or second electrode 542 of the pressure sensor 540, if they are opaque, may include at least one of Cu, Ag, Mg, Ti, and graphene. The materials of the first electrode 541 and/or second electrode 542 of the pressure sensor 540, if they are transparent, may include at least one of ITO, IZO, Ag nanowire, metal mesh, a transparent polymer conductor, and graphene. One of the first electrode 541 and the second electrode 542 may be a plate GND, and the other may be a repeated polygonal pattern. For example, the pressure sensor may use a self-capacitance scheme. One of the first electrode 541 and the second electrode 542 may be a first direction pattern (TX), and the other is a second direction pattern (RX) which is orthogonal to the first direction. For example, the pressure sensor may be a mutual capacitance scheme. The first electrode 541 of the pressure sensor may be formed on an FPCB and may be attached to the display panel 530, or may be directly formed on one side of the display panel 5330.

The pressure sensor 5040 may be referred to as, for example, a force sensor. The pressure sensor 540 may use a current induction scheme, in addition to the above-described self-capacitance scheme, or mutual capacitance scheme. It is apparent to those skilled in the art that any means that is capable of sensing the magnitude of pressure applied by a user to a portion of an electronic device when the user presses the portion of the electronic device, can be used as the pressure sensor 540, and the type and the disposed location thereof is not limited.

Although it is illustrated that the pressure sensor 540 is implemented as a single sensor in FIGS. 5A and 5B, the disclosure is not limited thereto and the pressure sensor 540 may be implemented as a set of two or more sensors. For example, the pressure sensor 540 may be implemented as a set of six sensors disposed in a 3×2 array.

When a touch (including hovering and/or “force touch”) by an external object (e.g., a finger of a user, an electronic pen, or the like) is received, a haptic actuator 550 may provide a tactual feedback (haptic feedback) (e.g., vibration) to a user. To this end, the haptic actuator 260 may include a piezoelectric member and/or a trembler, or the like.

Referring to FIGS. 5A and 5B, in the electronic device, the cover glass 510 is disposed at the top layer, the touch sensor 520 is disposed under the cover glass 510, and the display 530 is disposed under the touch sensor 520. The electronic device may include the pressure sensor 540 under the display panel 530, and the pressure sensor 540 includes the first electrode 541, the dielectric layer 543, and the second electrode 542. According to another embodiment, the electronic device may include the haptic actuator 550 under the pressure sensor 540.

The layer structures of the display of FIGS. 5A and 5B are merely examples, and there may be various modifications. For example, the touch sensor 520 may be directly formed on the back side of the cover glass 510 (e.g., a cover glass integrated touch panel), may be separately manufactured and inserted between the cover glass 510 and the display panel 530 (e.g., an add-on touch panel), may be directly formed on the display panel 530 (e.g., an on-cell touch panel), or may be included in the display panel 530 (e.g., an in-cell touch panel).

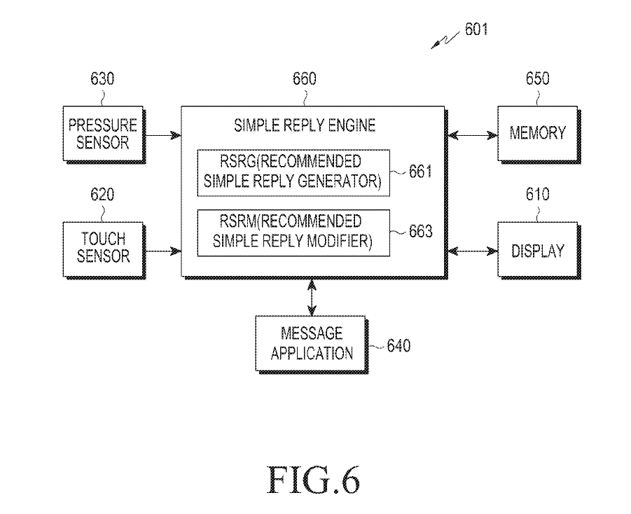

FIG. 6 is a block diagram illustrating the configuration of an electronic device for generating a recommended response to a received message according to various embodiments.

Referring to FIG. 6, an electronic device 601 (e.g., the electronic device 101) may generate a recommended response to a received message. For example, the recommended response may include text, an image, an avatar, and/or an emoticon.

The electronic device 601 may include a display 610 (e.g., the display 410), a touch sensor 620 (e.g., the touch sensor 420), an input sensor 630 (e.g., the pressure sensor 430), a message application 640, a memory 650 (e.g., the memory 450), and a simple reply engine 660. The simple reply engine 660 may be included in the processor 460 of FIG. 4. The simple reply engine 660 may include a recommended simple reply generator (RSRG) 661 and a recommended simple reply modifier (RSRM) 663. Descriptions of the configuration which have been provided with reference to FIGS. 1 to 4 will be omitted.

According to an embodiment, the electronic device 601 may generate a recommended response to the received message by the minimized operation (e.g., a touch input and/or a pressured input) by a user via the simple reply engine 660. For example, when a pressure input is received from the pressure sensor 630 or a touch input is received from the touch sensor 620 by a user's operation, the simple reply engine 660 may recommend and modify a response to the received message in the message application 640 using the pressure input and/or touch input. For example, the simple reply engine 660 may access the embedded memory 650 of the electronic device and/or an external memory so as to obtain the current received message, a previously received message, a previously sent message, sender information of the current received message, or information associated with an SNS interoperating with the sender and/or information associated with an SNS interoperating with a receiver (a user), and may recommend a response to the current received message using the above-described information.

For example, on the basis of the content of the received message, the RSRG 661 of the simple response engine 660 may generate a recommended response that a user may use, or may select at least one of stored recommended responses so as to generate a recommended response list. The RSRG 661 may generate a recommended response or may select a stored recommended response list using a message existing inside and/or outside the electronic device, a call history associated with the sender of the received message, SNS account information of the sender, and/or SNS account information of the receiver, in addition to the current received message of the electronic device 601.

According to an embodiment, the RSRG 661 may recognize the sender's intention of sending a message on the basis of a received message received from a sender and various text information (e.g., chatting information and message information), and may generate one or more recommended responses that the sender requires or may select a suitable recommended response from recommended responses stored in the electronic device. For example, the RSRG 661 may primarily generate a recommended response using text information of a received message that is received via the current chat window, in order to generate a “recommended response”. The RSRG 661 may secondarily generate a recommended response using the primarily generated recommended response and other text information included in the electronic device, and may provide the same to a user. For example, if data exists showing that the user talks down to a partner, a recommended response including a rough talk may be generated. Conversely, if data exists showing that the user uses the honorific form of language to a partner, a recommended response may be modified to include the honorific form of language. The RSRG 661 may generate a recommended response using dialogue data (text information) between the user and a partner of the received message via another application different from the application via which the current message is received.

According to an embodiment, the RSRG 661 may generate a recommended response using various context information such as sensing information, time information, schedule information stored in the electronic device, picture information stored in the electronic device, or the like, in addition to text information. For example, if the electronic device receives a message while the user runs, carrying the electronic device or another electronic device connected to (or interoperating with) the electronic device, the electronic device may detect the same using a motion sensor, the RSRG 661 may include content indicating that the user is running and currently is incapable of checking the message in a primarily generated recommended response or may replace the content with the primarily generated recommended response. For example, if the electronic device receives a message when the user does not use the electronic device for a long time and puts the electronic device on a desk, the electronic device may detect the same using a motion sensor, and the RSRG 661 may include the content indicating that the user leaves the electronic device as it is and does not check the message in the primary recommended response or may replace the content with the primary recommended response. For example, sound information input via a microphone (always on mic) (e.g., the microphone 288), location information input via a GPS, and the like may be included in a recommended response. For example, when a message “where are you?” is received, the electronic device may use the RSRG 661 so as to generate a primary response “on the way to Gangnam Station” using schedule information stored in the electronic device. Subsequently, the RSRG 661 may generate a response “I'm on a bus, currently at Seoul Nat'l UNIV. of Education Station, and it will take 15 minutes to get to Gangnam Station” using the sound information obtained via a microphone, motion information of the electronic device obtained via a motion sensor, and position information obtained via a GPS, and the like.

According to an embodiment, the RSRM 663 of the simple reply engine 660 may be a module to modify a recommended response that the RSRG 661 generates and provides to the user, and the RSRM 663 may change a property of the recommended response on the basis of a pressure input, a touch input, or a gesture input (e.g., swipe) by the user. For example, the user may select one of the various recommended responses provided by the RSRG 661, and when a suitable pressure is applied to a part of the selected response, the electronic device may change a property of the corresponding part. When the user selects a recommended response, “I will leave the office late today”, among the various recommended responses provided from the RSRG 661, and applies a pressure input to the word “late”, the RSRM 663 of the electronic device may increase the font size of the word “late” to correspond to the pressure input or may repeatedly display the word “late” in response to the user pressure input (“I will leave the office late late late today”). As another example, when the various recommended responses provided by the RSRG 661 are emoticons, the user may select one of the emoticons, and may apply a pressure input to the selected emoticon. In this instance, the RSRM 663 of the electronic device may display the emoticon by increasing the size of the emoticon or may repeatedly display the emoticon, or may change the emoticon to another emoticon in the same or similar category.

According to an embodiment, the simple reply engine 660 may be connected to the display 610, and may provide, to the user via the display 610, the recommended response and a modification of the recommended response on the basis of user's operation described below.

According to various embodiments, an electronic device may include: a touch screen display; a pressure sensor configured to detect a pressure on the touch screen display; a wireless communication circuit configured to transmit and receive a radio signal; at least one processor electrically connected to the touch screen display, the pressure sensor, and the wireless communication circuit; and a memory electrically connected to the processor. The memory stores instructions, and when the instructions are executed, the instructions enable the processor to perform: displaying, on the touch screen display, at least one response message to a message received via the wireless communication circuit; receiving at least one input via the touch screen display; and changing the at least one response message based on at least one of a pressure strength or a duration of the received input.

According to various embodiments, the instructions are configured to enable the processor to perform: identifying data which is related to the received message and is stored in the memory; and generating at least one response message based on a result of identification.

According to various embodiments, the instructions are configured to enable the processor to perform further receiving an input for selecting the at least one response.

According to various embodiments, the instructions are configured to enable the processor to perform transmitting the at least one changed response message.

According to various embodiments, the at least one response message includes at least one of text, an emoticon, an image, a video, or an avatar.

According to various embodiments, the instructions are configured to enable the processor to perform changing a color of the response message based on the pressure strength of the input to the response message.

According to various embodiments, the instructions are configured to enable the processor to perform scaling up or down a size of the response message based on the pressure strength of the input to the response message, and displaying the scaled response message.

According to various embodiments, the instructions are configured to enable the processor to perform displaying the response message and at least one additional response message corresponding to the response message on the touch screen when an input to the response message is detected.

According to various embodiments, when the response message includes a plurality of emoticons, the instructions are configured to enable the processor to perform: displaying a first emoticon at a designated location of the touch screen, displaying simplified text corresponding to the first emoticon, or displaying recommend text corresponding to the first emoticon, according to a pressure strength of an input to the first emoticon when the input to the first emoticon among the plurality of emoticons is detected.

According to various embodiments, when a response message to be included in the response message includes a plurality of emoticons, the instructions are configured to enable the processor to perform: scaling up or down a first emoticon according to a pressure strength of an input to the first emoticon when the input to the first emoticon among the plurality of emoticons is detected, and displaying the scaled first emoticon at a designated location of the touch screen.

According to various embodiments, the instructions are configured to enable the processor to perform: generating one or more recommended response messages to the received message; extracting at least one keyword associated with the recommended response messages; and determining the keyword as the response message.

According to various embodiments, the instructions are configured to enable the processor to perform: generating one or more recommended response messages to the received message; extracting at least one keyword associated with the recommended response messages; detecting at least one emoticon corresponding to the keyword; and determining the emoticon as the response message.

According to various embodiments, the instructions are configured to enable the processor to perform: displaying the response message on the touch screen display using information related to the received message when a pressure input of a first strength is detected from the touch screen display using the pressure sensor; and changing a property of the response message based on a pressure strength of the input to the touch screen display.

According to various embodiments, the property of the response message includes at least one of a size, a color, or a form.

According to various embodiments, the instructions are configured to enable the processor to perform: additionally displaying at least one of a user interface for changing at least one property corresponding to the response message or a user interface for additionally displaying a designated number of response messages corresponding to the response message according to a pressure strength of the input to the response message; and changing a property according to an input to the user interface for changing the at least one property.

According to various embodiments, the user interface for changing the at least one property includes at least one of a user interface for changing a color of the response message and a user interface for changing a size of the response message.

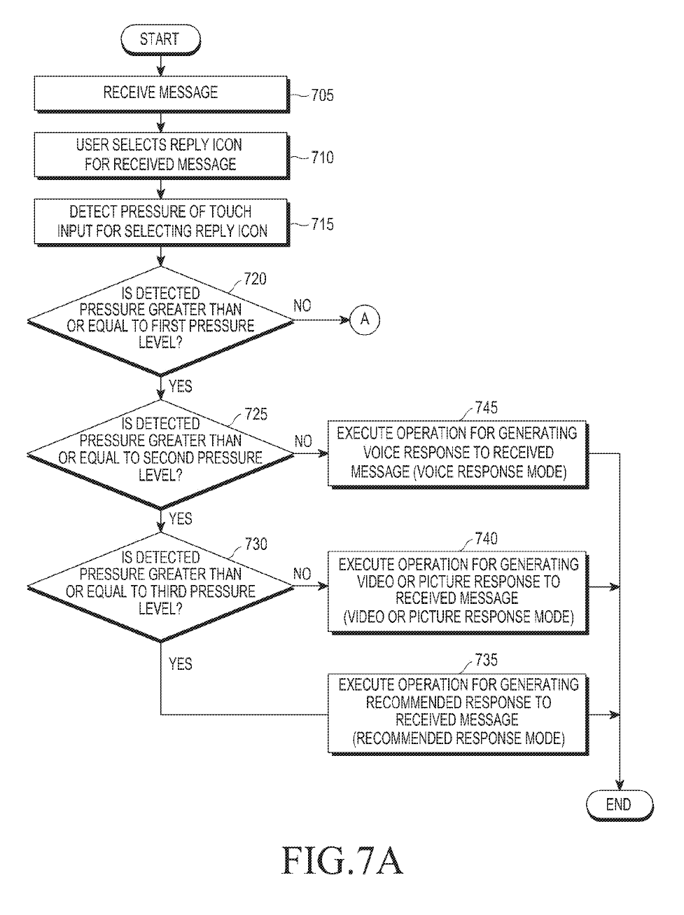

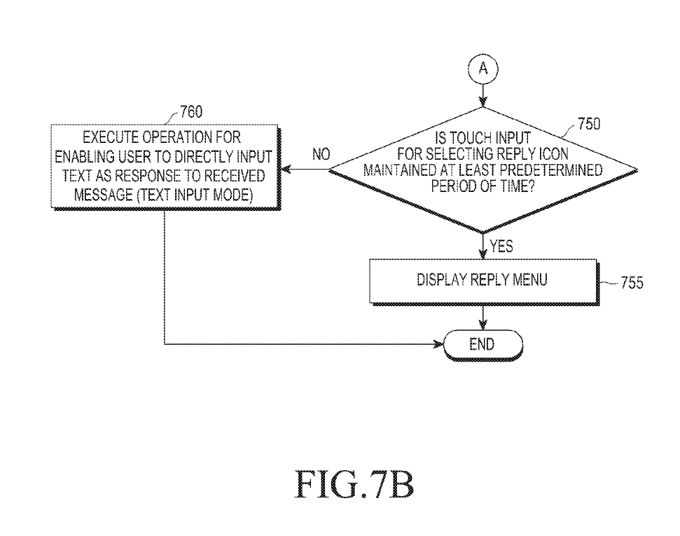

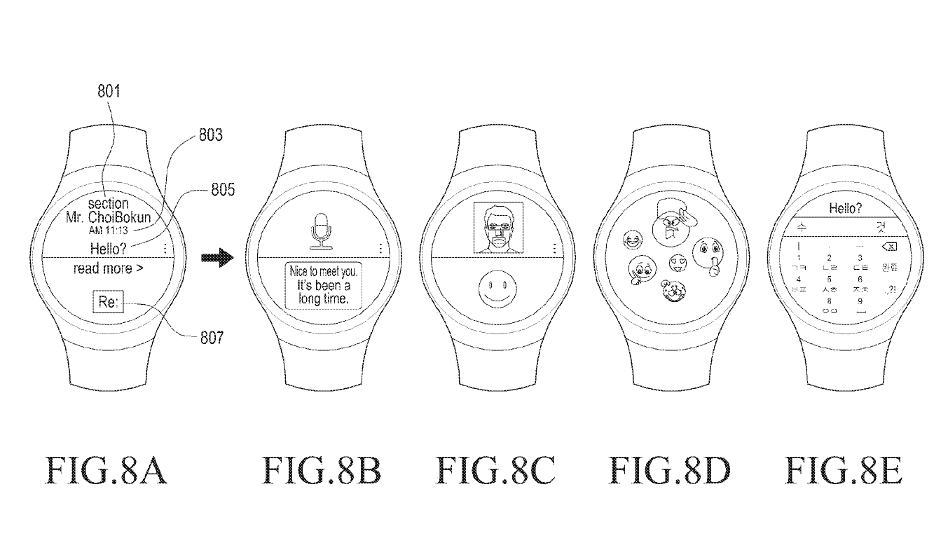

FIGS. 7A and 7B are flowcharts illustrating a process in which an electronic device (e.g., the electronic device 101) selects a scheme of responding to a received message on the basis of a user input according to various embodiments. FIGS. 8a to 8E are diagrams illustrating screens of an electronic device (e.g., the electronic device 101) that operates according to a scheme of responding to a received message selected by a user input according to various embodiments.

In operation 705, the electronic device may receive a message. According to an embodiment, when the electronic device receives a message, the electronic device may display, on a screen, sender information 801 of the received message, a reception time 803 of the received message, content 805 of the whole or a part of the received message, and/or a reply icon 807, as illustrated in FIG. 8A.

In operation 710, the electronic device may identify that the user selects a reply icon in association with the received message. For example, the electronic device may identify that a touch input to a reply icon 807 on the screen of FIG. 8A.

In operation 715, the electronic device may detect pressure associated with the touch input to select the reply icon.

In operation 720, the electronic device may determine whether the detected pressure is greater than or equal to a first pressure level. In operation 720, when the electronic device determines that the detected pressure is greater than or equal to the first pressure level, the electronic device proceeds with operation 725. Otherwise, the electronic device may proceed with operation 750.

In operation 725, the electronic device may determine whether the detected pressure is greater than or equal to a second pressure level. In operation 725, when the electronic device determines that the detected pressure is greater than or equal to the second pressure level, the electronic device proceeds with operation 730. Otherwise, the electronic device may proceed with operation 745.

In operation 730, the electronic device may determine whether the detected pressure is greater than or equal to a third pressure level. In operation 730, when the electronic device determines that the detected pressure is greater than or equal to the third pressure level, the electronic device proceeds with operation 735. Otherwise, the electronic device may proceed with operation 740.

In operation 735, the electronic device may perform an operation for generating a recommended response to the received message (a recommended response mode). For example, the electronic device may execute a recommended response mode that generates a response message using information related to the received message. For example, when pressure of the third pressure level is applied together with the touch to the reply icon 807 on the screen displayed as illustrated in FIG. 8A, the electronic device activates a simple reply engine, thereby generating an appropriate recommended response and recommending a response to the received message to the user. For example, the electronic device may generate a plurality of emoticons as a recommended response as illustrated in FIG. 8D. The operation of generating a recommended response performed in operation 735 will be described in detail later.

In operation 740, the electronic device may perform an operation for generating a video response or a picture response to the received message (a video or picture response mode). For example, the electronic device may perform the video or picture response mode that generates a response message using a video or a picture obtained using a camera of the electronic device. For example, when pressure of the second input level is applied together with the touch to the reply icon 807 on the screen displayed as illustrated in FIG. 8A, the electronic device may activate the camera so as to generate a video or picture response. For example, when pressure of the second pressure level is applied together with the touch to the reply icon 807 on the screen displayed as illustrated in FIG. 8A, the electronic device may display a screen for taking a shot of a picture or a video and the electronic device may use a simple picture or video shoot by the user as a response, as illustrated in FIG. 8C.

In operation 745, the electronic device may perform an operation for generating a voice response to the received message (a voice response mode). For example, the electronic device may execute a voice response mode that generates a response message using voice input via a microphone of the electronic device. For example, when pressure of the first pressure level is applied together with the touch to the reply icon 807 on the screen displayed as illustrated in FIG. 8A, the electronic device may activate a voice recording function and/or voice recognition function (e.g., S-Voice), may receive voice of the user, and may use the same as a response. For example, the user may directly transmit a recording file as a response. As another example, an input voice may be changed to text or emoticon using a speech to text (SST) or a speech to emoticon (STE), and the text or emoticon may be transmitted. For example, when pressure of the first pressure level is applied together with the touch to the reply icon 807 on the screen displayed as illustrated in FIG. 8A, the electronic device may display a screen via which the user inputs voice as illustrated in FIG. 8C, and when the user voice is input, the electronic device may change an input voice to text using the SST function and may display the text on the screen.

In operation 750, the electronic device may determine whether a touch input for selecting the reply icon is maintained during a predetermined period of time. When the electronic device determines that the touch input for selecting the reply icon is maintained during a predetermined period of time in operation 750, the electronic device may perform operation 755. Otherwise, the electronic device may perform operation 760.

In operation 755, the electronic device may display a reply menu. The reply menu may include a menu for executing the recommended response mode, a menu for executing the video or picture response mode, and/or a menu for executing the voice response mode.

In operation 760, the electronic device may execute an operation for enabling a user to directly input text as a response to the received message (text input mode). For example, the electronic device may execute the text input mode that generates a response message using text input via a virtual keypad. For example, when the reply icon 807 is selected by simply touching the screen displayed as illustrated in FIG. 8A, the electronic device may activate a text input tool such as a virtual keypad as illustrated in FIG. 8E, so that the user may directly input text using the activated text input tool and may write a response.

According to an embodiment, the electronic device may generate a recommended response by combining one or more responding schemes among the above-described responding schemes. For example, the electronic device may generate a single recommended response by combining image data obtained by photo shooting and voice recording data. As another example, the electronic device may combine the generated recommended response and a photo shoot image, may recognize user's emotion on the basis of a keyword provided via the recommended response, and may generate a recommended response using the same by modifying or replacing the photo shoot image. As another example, the electronic device may use an image analysis technology so as to recognize user's emotion information from the photo shoot image of the user, may generate text in connection with an existing recommended response, and may transmit the same to the user.

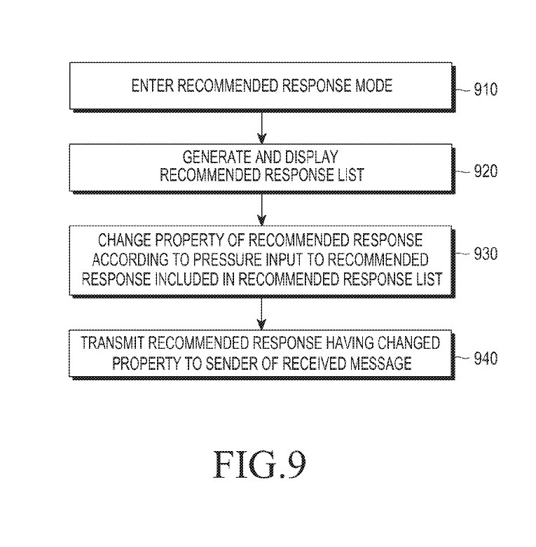

FIG. 9 is a flowchart illustrating an operation of executing a recommended response mode by an electronic device according to various embodiments. Referring to FIG. 9, the electronic device may generate a recommended response to a received message, and may transmit the recommended response to a sender of the received message.

In operation 910, the electronic device may enter the recommended response mode. For example, according to the location and/or strength of a pressure input by a user, the electronic device may enter the recommended response mode for executing an operation of generating a recommended response to the received message.

In operation 920, the electronic device may generate and display a recommended response list. For example, the electronic device may generate one or more recommended response lists including one or more recommended responses, and may provide the one or more recommended response lists to the user. For example, the form of a recommended response provided by the electronic device may be provided in the form of text, an image, an emoticon, or video, and may be in the form of a combination thereof. The recommended response list may be a unit for displaying one or more recommended responses, and may include a set of one or more recommended responses.

According to various embodiments, when a plurality of recommended response lists exists, the electronic device may provide a means of switching between the plurality of recommended response lists. According to an embodiment, the electronic device may switch one or more recommended response lists according to a user's gesture, and may display the same on a display. For example, when a first recommended response list and a second recommended response list exist, the electronic device may display the first recommended response list on the screen, and the electronic device may display the second recommended response list on the screen in response to a user gesture (e.g., a swipe gesture (a gesture that moves a finger a predetermined distance by holding a touch on the screen).

According to an embodiment, according to a user's operation given on a physical button or a logical button (UX icon) attached to the electronic device, the electronic device may switch a recommended response list and may display the same on the screen. For example, when the first recommended response list and the second recommended response list exist, the electronic device may display the first recommended response list on the screen, and may switch the first recommended response list to the second recommended response list as the user selects an icon, a button, and the like.

According to an embodiment, as the user of the electronic device rotates the stem of a watch or the wheel of the electronic device provided in the form of a smart watch or the like, the electronic device may switch and display the recommended response lists on the screen. For example, when the electronic device is a smart watch, the electronic device may return to a step which was selected before the user applies pressure, using the stem of the smart watch or the wheel of the smart watch.

The operation of generating a recommended response list performed in operation 920 will be described in detail later.

In operation 930, the electronic device may change a property of a recommended response according to a pressure input to the recommended response included in the recommended response list of the user. For example, the selected recommended response may be modified or corrected by a pressure input by the user.

According to an embodiment, when the user selects a recommended response including text, the electronic device may change a property (add user's emotion) by adding, changing, or repeating a modifier or intensifier designated in an input word or phrase to which pressure is input by the user. For example, the modifier that is added or repeated may have a repeating chain (e.g., may generate animation with a plurality of emoticons), and may be repeated by a predetermined period and exposed to a user according to a pressure input by the user.

According to an embodiment, when a pressure input by the user is applied to a recommended response including an image, the electronic device may modify the image at the location at which the corresponding pressure is applied. For example, when the image is a facial image and pressure is applied to a part corresponding to the mouth of the face, the electronic device may modify, scale up, or change the shape of the mouth in proportion to the applied pressure, so as to deliver various emotions.

According to an embodiment, when a pressure input by the user is applied to a recommended response including an emoticon, the electronic device may modify the shape of an emoticon at the location of the pressure input, or may replace the currently displayed emoticon with another emoticon belonging to the same or similar category. For example, when the user selects a part corresponding to an eye of the emoticon selected as a recommended response, the electronic device may replace the corresponding eye with another shape so as to modify the emoticon. The emoticon may be modified by emphasizing or weakening a recommended property. For example, in the state in which an emoticon associated with “smile” is selected, when the user applies pressure to a part corresponding to an eye, the electronic device may change the emoticon to an emoticon showing that the degree of smiling is elevated. For example, when the user applies pressure to an emoticon, the electronic device may replace the corresponding emoticon with similar emoticons or may change a property (e.g., a size, a color, or effects) of the emoticon, so as to help the user select the final shape of an emoticon.

The operation of changing a property of the recommended response according to a pressure input to the recommended response, which is performed in operation 930 will be described in detail later.

In operation 940, the electronic device may transmit the recommended response including the changed property to the sender of the received message.

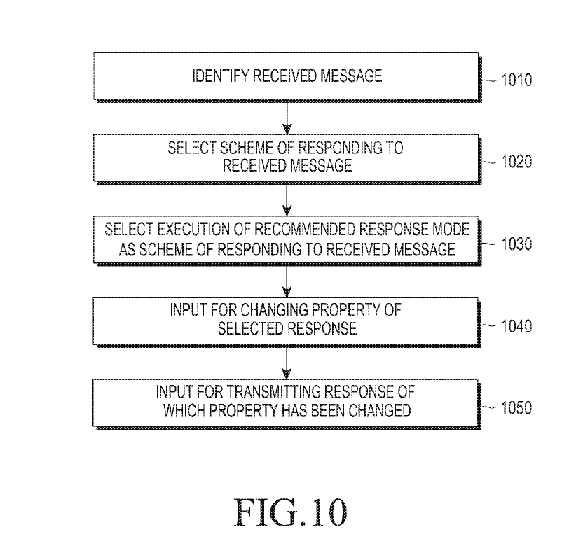

FIG. 10 is a diagram illustrating a process in which a user operates an electronic device until transmission of a recommended response to a received message according to various embodiments. Referring to FIG. 10, the user may enable the electronic device to quickly transmit a suitable response to a received message, using only the minimum touch and/or pressure input by an operation illustrated in FIG. 10.

The user may identify a received message that is received and displayed by the electronic device in operation 1010. In operation 1020, the user may select a scheme of responding to the received message by selecting a reply icon in association with the received message which is displayed on a screen of the electronic device. In operation 1030, the user may select execution of a recommended response mode as a scheme of responding to the received message. In operation 1040, the user may provide an input to change a property of a selected response. In operation 1050, the user may provide an input to transmit a response of which the property has been changed.

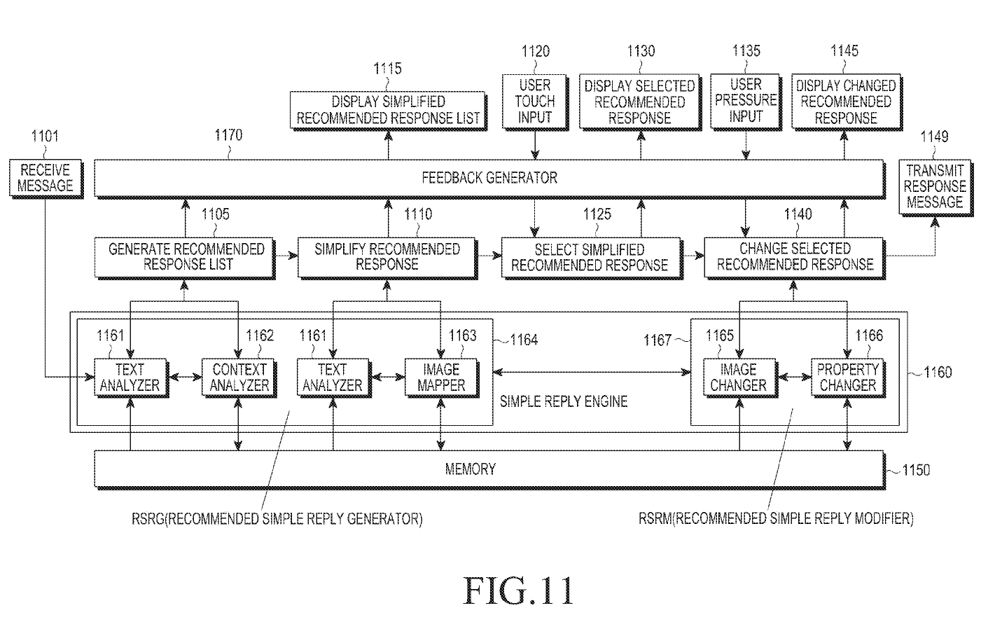

FIG. 11 is a flowchart illustrating a control operation of an electronic device that generates a recommended response to a received message and transmits a response message to a sender according to various embodiments.

The electronic device may be the electronic device 101 of FIG. 1. The electronic device may include a memory 1150 (e.g., the memory 130), a simple reply engine 1160 (e.g., the simple reply engine 660), and a feedback generator 1170. The simple reply engine 1160 may include an RSRG 1164 and an RSRM 1167. The RSRG 1164 may include a text analyzer 1161, a context analyzer 1162, or an image mapper 1163. The RSRM 1167 may include an image changer 1165 and a property changer 1166.

In operation 1101, the electronic device may receive a message. For example, the electronic device may receive a message from a sender over a network.

In operation 1105, the RSRG 1064 of the electronic device may generate a recommended response list including one or more recommended responses to the received message, using the text analyzer 1061 and the context analyzer 1062. For example, the electronic device may generate or select various recommended responses that the user is capable of using, on the basis of content of the received message, information associated with the sender, and/or records of messages that are previously exchanged with the sender, and the like.

According to an embodiment, the recommended response may be generated newly on the basis of the received message, or may be selected and recommended on the basis of some recommended responses included in a stored recommended response list. For example, the electronic device may select a recommended response by utilizing various pieces of context information of the electronic device, in addition to stored message information or user information. For example, the electronic device may change the recommended response using sensor information, time information, and/or user's schedule information and the like. For example, the recommended response may be generated on the basis of user's emotion information monitored by the electronic device or received from another electronic device. For example, the electronic device may generate a recommended response differently depending on a time. For example, the electronic device may change the content of the recommended response depending on a schedule.

According to an embodiment, the electronic device may use at least one of information related to the received message, sender information, user information of the electronic device (receiver information), information stored in the electronic device, or sensor information of the electronic device (e.g., motion sensor information, GPS information, gyro sensor information, grip sensor information, and the like), and may finally determine a recommended response according to a priority designated to the information. For example, the electronic device may prioritize schedule information, which is information stored in the electronic device, over information related to the received message. When schedule information indicates “being in class”, a recommended response, “I'm in class now. I will call you later.”, corresponding to the schedule information may be generated irrespective of the content of the received message.

In operation 1110, the RSRG 1164 may simplify one or more recommended responses included in the recommended response list using the text analyzer 1161 and the context analyzer 1162. For example, the electronic device may simplify the recommended response so as to change the recommended response to be in a form that may be easily used by a device with a limited-sized display, such as a wearable device or the like. For example, the electronic device may extract a main keyword from the recommended response by performing phrase analysis using the text analyzer 1161 and performing context analysis using the context analyzer 1162, so as to generate a simplified recommended response list. The simplified recommended response list may indicate a set including one or more main keywords. For example, the electronic device may map an emoticon, an image, an avatar, or the like that corresponds to the main keyword, using the image mapper 1063. The simplified recommended response list may indicate a set including one or more emoticons, one or more images, or one or more avatars.

In operation 1115, the electronic device may display the simplified recommended response list via the feedback generator 85.

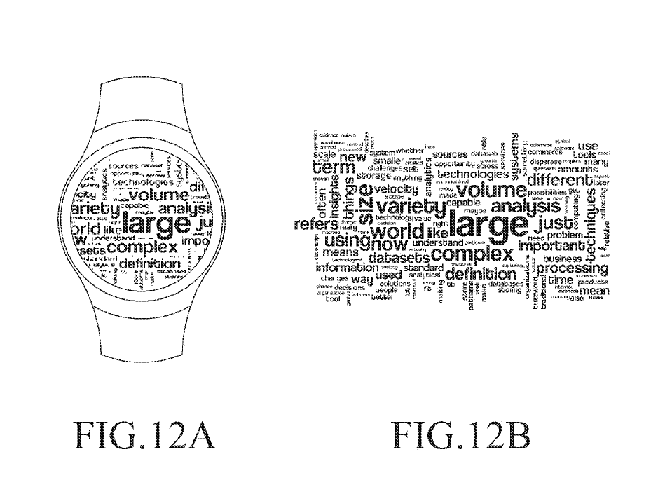

Referring to FIG. 12, when the simplified recommended response list is a set including one or more main keywords, for example, a main keyword list, the electronic device (e.g., the electronic device 101) may display, on the screen, the simplified recommended response list in the form of a graphic. For example, as illustrated in FIG. 12A, the electronic device may display the simplified recommended response list by changing properties of respective recommended words, so as to have different sizes, different fonts, or different colors, depending on the basis of the degree of association with a main keyword, the degree of repetition, the degree of recommendation, or the like. For example, the electronic device may display a part of the main keyword list generated as illustrated in FIG. 12B in the electronic device as illustrated in FIG. 12A. The electronic device may move the main keyword list according to a gesture input (e.g., a swipe input) by the user, so as to enable the user to select a main keyword.

According to another embodiment, when the simplified recommended response message list is a set including one or more main keywords, for example, a main keyword list, the electronic device may display, on the screen, the main keywords of the main keyword list one by one.

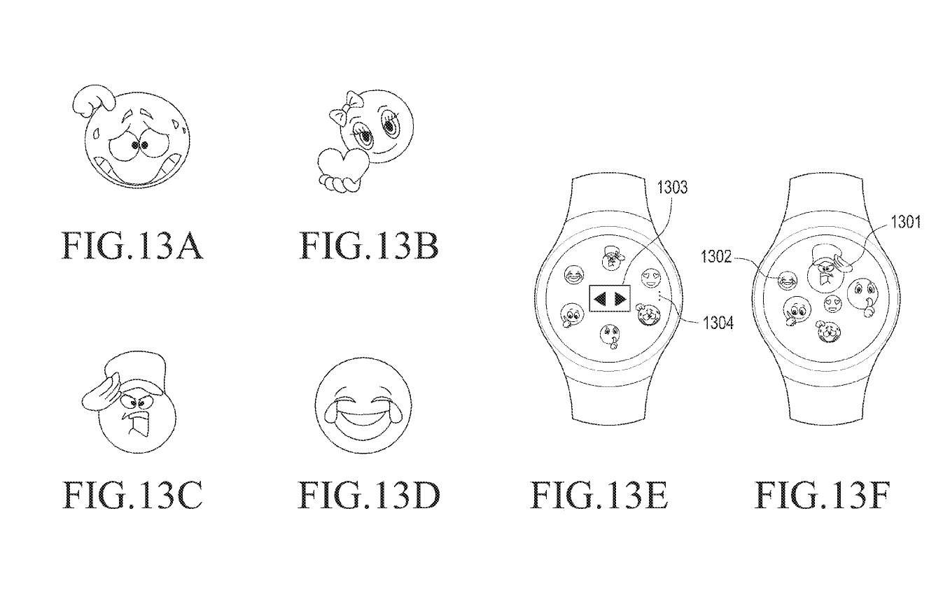

Referring to FIG. 13, the simplified recommended response list may be a set including one or more emoticons, for example, an emoticon list. According to an embodiment, the electronic device may select a suitable emoticon using a main keyword selected from a simplified recommended response message list, and may recommend the selected emoticon to the user. For example, the electronic device may recommend one or more stored emoticons corresponding to the selected main keyword. For example, when the selected main keyword is “mistake”, the electronic device may recommend and display an emoticon of FIG. 13A. When the selected main keyword is “love”, the electronic device may recommend and display an emoticon of FIG. 13B. When the selected main keyword is “army”, the electronic device may recommend and display an emoticon of FIG. 13C. When the selected main keyword is “laugh”, the electronic device may recommend and display an emoticon of FIG. 13D.

According to another embodiment, the electronic device may generate a recommended response list using one or more recommended emoticons, and may display the same in a list as illustrated in FIG. 13E. Referring to FIG. 13E, the electronic device may further display a first icon 1303 and a second icon 1304, in addition to the recommended emoticons. When recommended emoticons, the number of which is greater than the number of emoticons that the screen of the electronic device allows to display, exist, for example, when a second recommended emoticon set in addition to a first recommended emoticon set exists, the first icon 1303 may be an icon to switch a page of an emoticon set such that the user may check the second recommended emoticon set. For example, when the user presses the left arrow, the electronic device may display a previous emoticon set on the screen. When the user presses the right arrow, the electronic device may display a next emoticon set on the screen. The second icon 1304 may be an icon to enter an option. For example, when the user selects the second icon, the electronic device may display a menu window on the screen, and may determine whether to provide an emoticon response or to change to a text response, using the same.

According to another embodiment, when a recommended response is generated in the form of an emoticon, the electronic device may change properties of respective recommended emoticons so as to have different sizes or different colors, depending on the degree of association between a main keyword and the corresponding emoticon, the degree of repetition, or the degree of recommendation. Referring to FIG. 13F, the electronic device may display the first emoticon 1301, which is highly associated with the main keyword, to be the largest, and may display the second emoticon 1302, which has the lowest association with the main keyword, to be the smallest. In this way, the electronic device may display emoticons in different sizes depending on the degree of association with the main keyword. Emoticons may be displayed in a list, on the screen. The electronic device may differently display an emoticon by adding an intensifier to the emoticon, adding an emoticon, changing a background, or providing an animation effect, depending on the degree of association with the selected main keyword, the degree of repetition, or the degree of recommendation. The degree of repetition may indicate displaying an emoticon, which is frequently used by the user, to be visually distinguished from other emoticons. The intensifier may indicate displaying an emoticon to be visually distinguished from others (e.g., marking the boundary of the emoticon to be bold, or adding a predetermined symbol (e.g., V or the like)). For example, when a recommended response is generated and displayed in the form of an emoticon, the electronic device may display a highly related emoticon among a plurality of recommended emoticons to be distinguished from others. For example, the electronic device may display emoticons in different sizes in order of highest recommended responses. For example, when the first, second, third, and fourth emoticons are displayed on the screen as recommended responses, if the electronic device highly recommends the first emoticon, the electronic device may set the size of the first emoticon to 10, and if the electronic device second highly recommends the third emoticon, the electronic device may set the size of the third emoticon to 8.

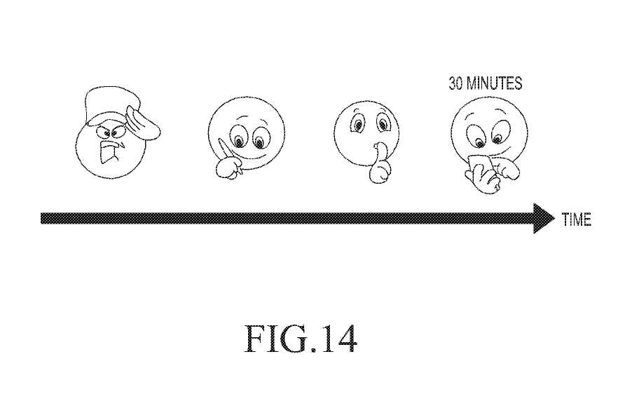

Referring to FIG. 14, the electronic device may display emoticons in the form of animation by combining keywords of a received message. For example, the electronic device may combine one or more emoticons by combining main keywords of the entire message of the received message so as to generate a GIF file in the form of animation, and may recommend the same to the user. For example, the electronic device may generate the emoticons corresponding to a plurality of main keywords to be the GIF file in the form of animation, as illustrated in FIG. 14. For example, depending on the degree of association of an individual emoticon, the electronic device may emphasize the content of the corresponding emoticon by controlling a property of the emoticon such as a size, a color, or the like, or by controlling the speed of playback of animation.

Referring to FIG. 11, in operation 1120, the electronic device may receive a touch input by a user to a simplified recommended response in a simplified recommended response list. In operation 1125, the electronic device may select the simplified recommended response according to the user's touch input, using the feedback generator 1170. In operation 1130, the electronic device may display the selected recommended response using the feedback generator 85.

For example, the electronic device may select a recommended response according to a touch input and/or a pressure input, from the simplified recommended response list which is recommended by the electronic device and is displayed on the screen. For example, the selected recommended response may be scaled up and may be displayed on the screen.

In operation 1135, the electronic device may receive a pressure input by the user. In operation 1140, the SSRM 1067 may change the selected recommended response according to the pressure input by the user. In operation 1145, the electronic device may display the changed recommended response using the feedback generator 1170. For example, the electronic device may change the selected recommended response using the image changer 1067 and the property changer 1065 of the RSRM 1066.

According to an embodiment, as a user provides an input, and the electronic device generates a recommended response, updates a recommended response, or changes a property of a recommended response, the electronic device may generate feedback such as vibration/sound/screen animation effects or the like using the feedback generator 1170 and may provide the feedback to the user. For example, the degree of feedback may be increased or decreased in proportion to a property (“emotion” express) of a recommended response that changes according to a user input. For example, if the magnitude of vibration occurring when the user changes the size of an emoticon from 1 to 2 by a pressure input is 1, the electronic device may set, to 2, the magnitude of vibration occurring when the electronic device changes from 2 to 3 according to a pressure input by the user. For example, the electronic device may enable the intensity of vibration or the degree of visual effect to be increased or decreased in proportion to the number of times that a pressure input is applied.

Referring to FIG. 15, when recommended icons are displayed on a screen of the electronic device as illustrated in FIG. 15A, if a first set pressure or less is input to a first emoticon 1501, the electronic device may display the first emoticon 1501 as it is as illustrated in FIG. 15B. If a second set pressure is input to the first emoticon 1501, the electronic device may select a response that is obtained by changing the first emoticon 1501 into a simplified text form, and may display “Hey! How are you?” which is simplified text corresponding to the first emoticon 1501, as illustrated in FIG. 15C. If a third set pressure is input to the first emoticon 1501, the electronic device may select a response in the form of a recommended response corresponding to the first emoticon 1501, and may display “Hey! How are you? I'm in class now and I will call you back within 30 minutes” which is a recommended response corresponding to the first emoticon 1501 as illustrated in FIG. 15D.

According to an embodiment, when one or more simplified recommended response lists exist which are recommended and generated, the electronic device may switch the simplified recommended response lists according to a gesture input (e.g., a swipe input). The electronic device may select a simplified recommended response by a pressure input.

According to another embodiment, when the electronic device is a smart watch, the electronic device may switch the simplified recommended lists by rotating the stem of the watch or rotating a wheel, or by applying pressure to the external frame of the electronic device. The electronic device may select a simplified recommended response by a pressure input.

According to another embodiment, if a pressure input is applied to the selected recommended response, the electronic device may change a property of the simplified recommended response which is selected by a touch and/or a pressure, so as to generate a desired final response. For example, the property of the recommended response may be variously defined depending on the form and the type of a recommended response. For example, if the recommended response is in the form of text, the properties may be the size, color, font, thickness, tilt, underline, and/or an animation effect associated with text and the like. For example, if the recommended response is in the form of an emoticon, the properties may be the size, color, an animation effect, and/or replacement associated with emoticon and the like.

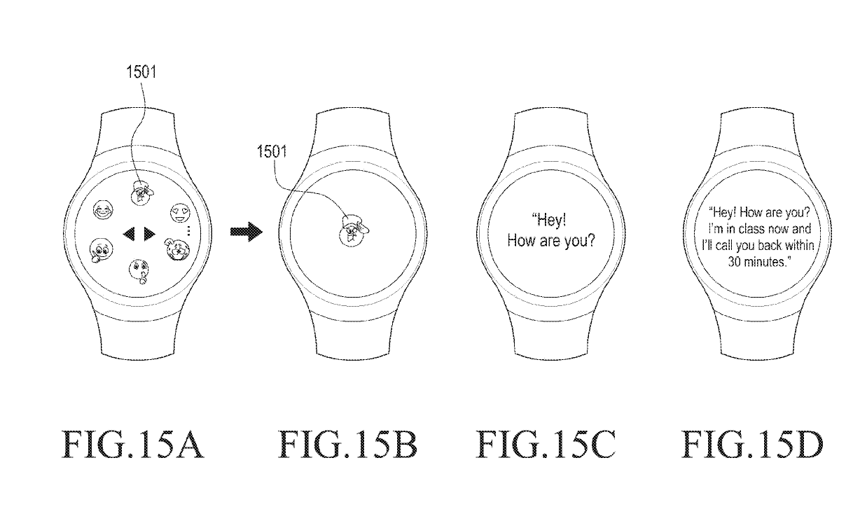

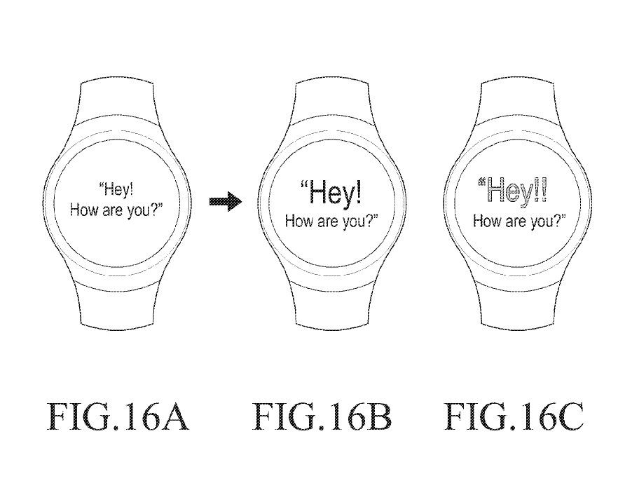

Referring to FIG. 16, when a recommended response is text such as “Hey! How are you?” as illustrated in FIG. 16A, if a pressure input is applied to the text “Hey!”, the electronic device may scale up the size of the text “Hey!” as illustrated in FIG. 16B or may change the color of the text “Hey!” to red as illustrated in FIG. 16C, according to the strength and/or location of the pressure input.

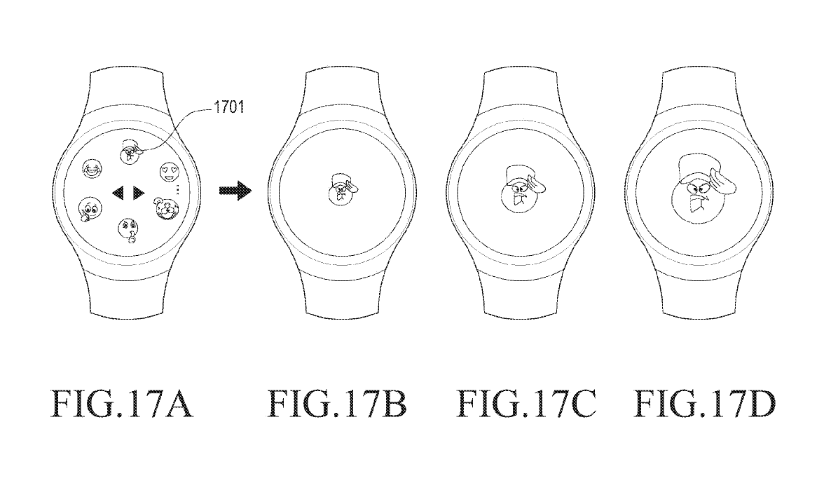

Referring to FIG. 17, the electronic device may display, on the screen, emoticons in different sizes according to the strength of a pressure input provided when the user selects the type of an emoticon. When a recommended response list including a plurality of emoticons is displayed as illustrated in FIG. 17A, if a pressure input is provided to a first emoticon 1701, the size of an emoticon that the electronic device may select or display may be different according to the strength of a pressure input, for example, the emoticon of FIG. 17B may be selected or displayed in response to a first strength, the emoticon of FIG. 17C may be selected or displayed in response to a second strength, and the emoticon of FIG. 17D may be selected or displayed in response to a third strength.

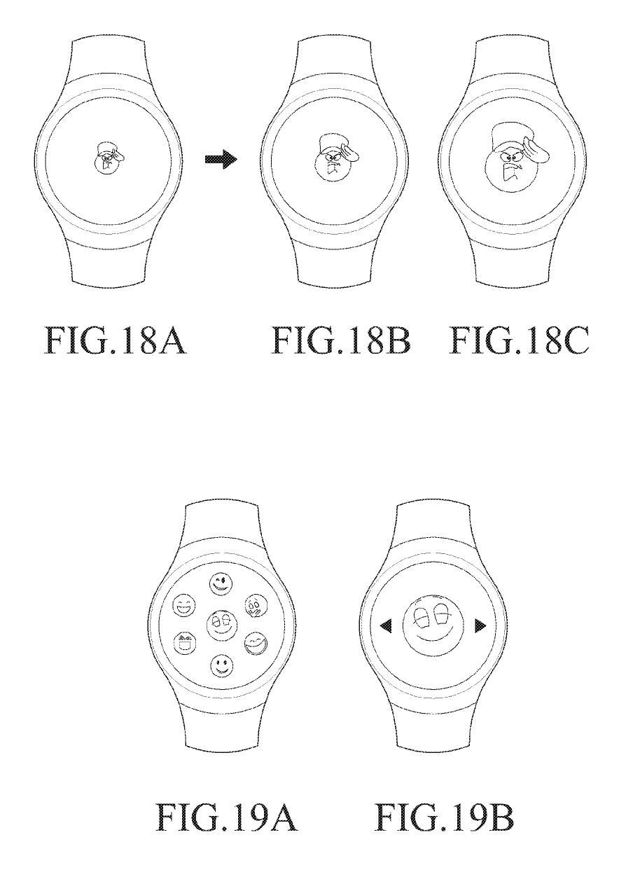

Referring to FIG. 18, if a pressure input is provided to an emoticon selected as a recommended response as illustrated in FIG. 18A, the electronic device may change the size of an emoticon depending on the strength of the pressure input, for example, the emoticon of FIG. 18A is changed to the emoticon of FIG. 18B in response to a first strength, and the emoticon of FIG. 18A is changed to the emoticon of FIG. 18C in response to a second strength.

According to an embodiment, the electronic device may gradationally change the size of an emoticon according to a pressure magnitude section defined in association with a user's pressure input.

According to another embodiment, the electronic device may linearly change the size of an emoticon in proportion to a pressure input by a user. For example, the electronic device may determine the minimum and maximum size of an emoticon that may be expressible in consideration of the size of a display, and connect the determined size of an emoticon and the detectable strength of a pressure input so as to continuously change the size of the emoticon according to a change in the pressure applied by a user.

Referring to FIG. 19, when an emoticon of “smiling face” that expresses delight is selected and a pressure input or a touch swipe is input to the selected emoticon, emoticons of various smiling faces which correspond to the emoticon of “smiling face” may be displayed as illustrated in FIG. 19A. When the emoticon of “smiling face” that expresses delight is selected, the electronic device may display the emoticon of “smiling face” on the screen as illustrated in FIG. 19B. Subsequently, when the user inputs a pressure input or a touch swipe to the emoticon of “smiling face”, the electronic device may change the emoticon of “smiling face” to an emoticon of another smiling face which corresponds to the emoticon of “smiling face”, and may display the same.

According to another embodiment, the electronic device may change an emoticon by increasing or decreasing the degree of expression of user's emotion recommended by the electronic device, according to a pressure input by the user. For example, when the electronic device recognizes the state of a user as “in meeting—busy” and displays an emoticon corresponding thereto on the screen, if the user inputs a pressure input, the electronic device may change the emoticon corresponding to “in meeting—busy” to another state “in meeting—busier”, “in meeting—much busier”, or the like. For example, according to a pressure input, the electronic device may display an emoticon corresponding to “in meeting—busier”, an emoticon corresponding to “in meeting—much busier”, or the like, instead of the emoticon corresponding to “in meeting—busy”.

According to an embodiment, when the electronic device displays an emoticon corresponding to “happy/joyful” selected as a predictive response for the user, if the user inputs a pressure input, the electronic device may display an emoticon corresponding to “more happy/more joyful” or an emoticon corresponding “a little happy/a little joyful” which shows increase or decrease in the grade of “happy/joyful”, according to the pressure input by the user.

According to an embodiment, a property may be changed by controlling the actual property of an object of the final result which is finally displayed. Alternatively, a property may be changed by changing metadata or additional information of the corresponding object as opposed to changing a property of the final result. For example, in the case of markup language such as HTML or the like, the electronic device may change a property by correcting tag information connected to the corresponding object, as opposed to changing the final result object. For example, in response to a request for changing a color from the user, the electronic device may provide effects by changing only tag information indicating color information of the corresponding object, as opposed to changing to or generating an object having a new color. As another example, in response to a request for changing a property from the user, the electronic device may change font=3 to font=5, or may change a bold/Italic/color property tag, thereby changing an object.

According to an embodiment, a scheme of changing an emoticon selected as a recommended response and a property thereof may be implemented by an avatar generated or selected by the user.

According to an embodiment, the electronic device may select one of the various properties according to the strength of a pressure input or the number of times that a pressure input is provided by the user. The electronic device may determine the amount of variation in a selected property according to the duration of a touch. According to another embodiment, the electronic device may select one of the various properties according to a swipe motion made by the user. The electronic device may determine the amount of variation in a selected property according to the strength of a pressure.

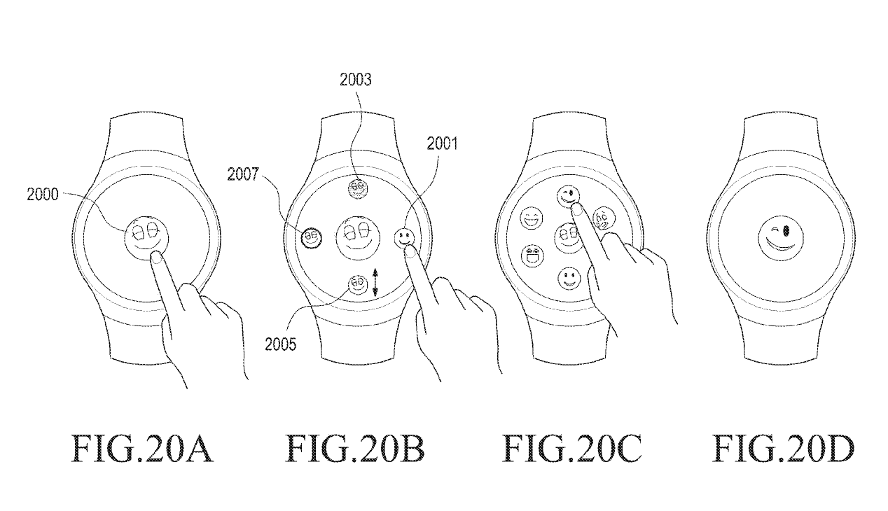

Referring to FIG. 20, the electronic device may display various properties while the user applies a pressure. In the state of maintaining a touch, when the user selects a property and subsequently makes a swipe motion and a pressure input motion, the electronic device may determine the amount of variation in the corresponding property.

When the user applies a pressure input to an emoticon 2000 displayed as shown in FIG. 20A, the electronic device may display the properties 2001, 2003, 2005, and 2007 of the emoticon that the electronic device may change as illustrated in FIG. 20B, while the pressure input is applied. As illustrated in FIG. 20B, when the user makes a swipe gesture in the state of maintaining a touch, so as to select a first property 2001 for changing the shape of an emoticon, the electronic device may display emoticons which have similar shapes as that of the currently selected emoticon, on the screen as illustrated in FIG. 20C, while the touch is maintained. When the user applies an additional pressure input to one of the emoticons that are similar to the currently selected emoticon as illustrated in FIG. 20C, the electronic device may select the corresponding icon according to the additional pressure input, and may display the same on the screen as illustrated in FIG. 20D. For example, the electronic device may terminate changing a property of the corresponding emoticon at the same time at which the user removes a touch input.

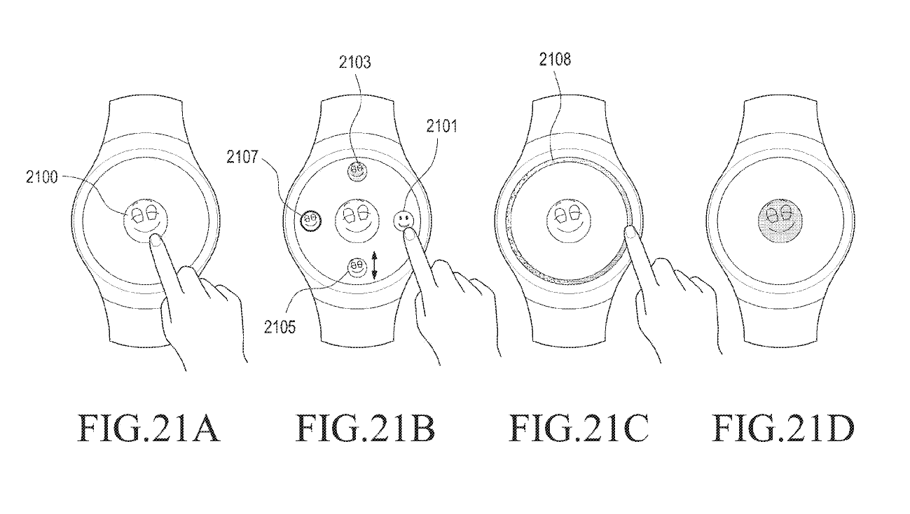

Referring to FIG. 21, when the user applies a pressure input to an emoticon 1800 displayed as illustrated in FIG. 21A, the electronic device may display the properties 2101, 2103, 2105, and 2107 of the emoticon that the electronic device may change as illustrated in FIG. 21B, while the pressure input is applied.

As illustrated in FIG. 21B, in the state of continuously maintaining a touch, when the user makes a swipe gesture so as to select the second property 2103 for changing the color of the emoticon, the electronic device may display a UI 2108 for changing the color of the emoticon on the screen as illustrated in FIG. 21C, while the touch is maintained. As illustrated in FIG. 21C, when an additional input is provided to a predetermined color selected by the user, for example, when the user selects a predetermined color by a swipe gesture in the state of continuously maintaining the touch, the electronic device may apply the predetermined color to an emoticon 2100 and may display the same. The electronic device may terminate changing a property of the corresponding emoticon at the same time at which the touch input is removed.

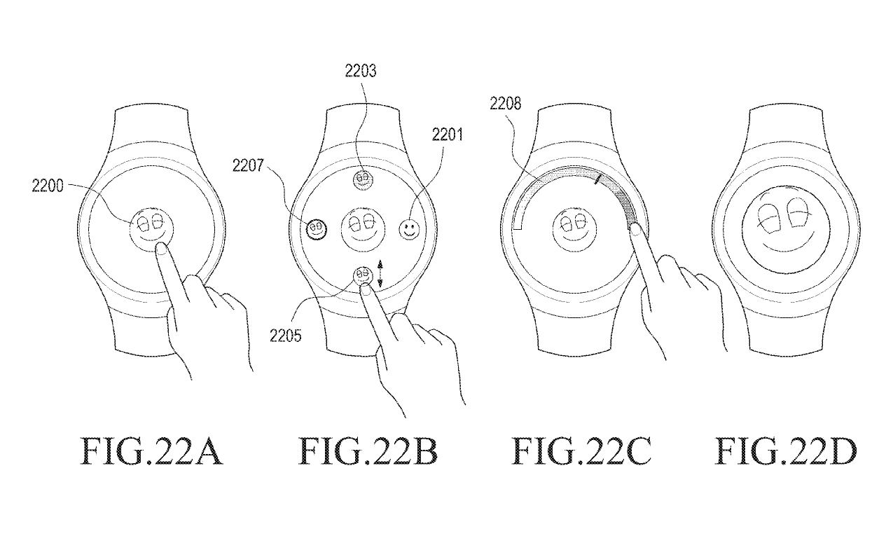

Referring to FIG. 22, when the user provides a pressure input to an emoticon 2200 displayed as illustrated in FIG. 22A, the electronic device may display the properties 2201, 2203, 2205, and 2207 of the emoticon that the electronic device may change as illustrated in FIG. 21B, while the pressure input is applied by the user.

As illustrated in FIG. 22B, in the state of continuously maintaining a touch, when the user makes a swipe gesture so as to select the third property 2205 for changing the size of the emoticon, the electronic device may display a UI 2208 for changing the size of the emoticon on the screen as illustrated in FIG. 22C, while the touch is maintained. As illustrated in FIG. 22C, when an additional input is provided to a predetermined size selected by the user, for example, when the user selects a predetermined size by a swipe gesture in the state of continuously maintaining the touch, the electronic device may apply the predetermined size to an emoticon 2200 and may display the same. The electronic device may terminate changing a property of the corresponding emoticon at the same time at which the touch input is removed.

In operation 1149, the electronic device may determine the changed recommended response to be a response message, and may transmit the response message to the sender that transmits the message. For example, the electronic device may determine, to be the response message, the recommended response that is changed according to a user input (e.g., a touch input, a pressure input, a voice input, or a gesture input) for transmitting a response message, and may transmit the response message to the sender that transmits the message. For example, the electronic device may display a user interface for transmitting the response message on the screen, and when the user selects the user interface for transmitting the response message, the electronic device may transmit the response message to the sender that transmits the message.

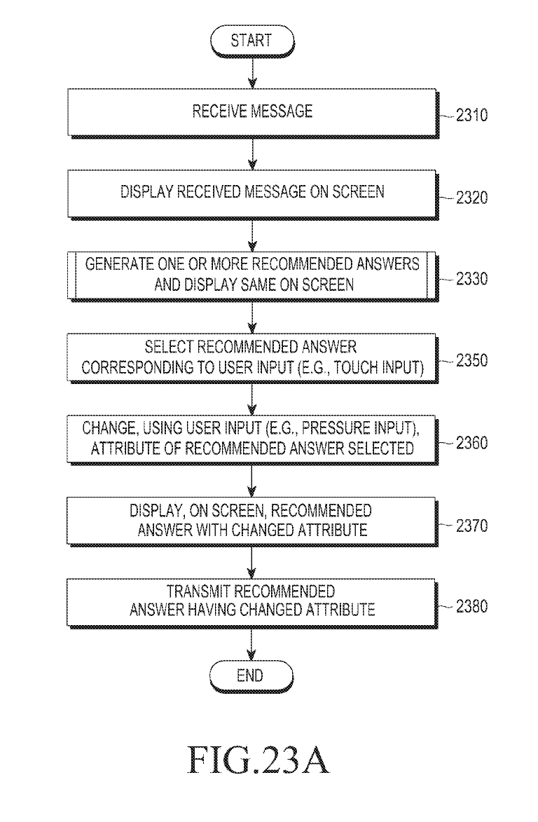

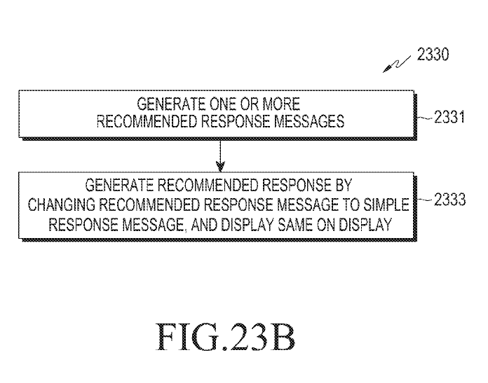

FIGS. 23A and 23B are flowcharts illustrating a control operation of an electronic device (e.g., the electronic device 231) according to various embodiments. Referring to FIGS. 23A and 23B, the electronic device may provide convenience for a user in association with an operation of receiving a message and transmitting a response to the received message. For example, in the case of a wearable device having a display and an input device which are limited in size, such as a smart watch, the user may simply check and consume a message, and may also quickly and simply generate an immediate response. For example, the electronic device may quickly provide a recommended response (reply) to the message that the user receives.

In operation 2310, the electronic device may receive a message.

In operation 2320, the electronic device 101 may display the received message on a screen.

In operation 2330, the electronic device may generate one or more recommended responses to the received message, and may display the same on the screen.

The operation of generating and displaying the recommended responses on the screen, which is performed in operation 2330, may be implemented according to operations 2331 and 2333 of FIG. 23B.

For example, the electronic device may generate one or more recommended response messages in operation 2331. For example, the electronic device may predict a response message on the basis of information existing inside or outside the electronic device, such as the received message, a previously received message, SNS account information of a sender, or the like, and may generate a recommended response message.

In operation 2333, the electronic device may change the one or more recommended response messages to a simplified response message so as to generate a recommended response, and may display the same on the screen of the electronic device. For example, the electronic device may change the recommended response messages to text, an image, an avatar, an emoticon, or the like, and may display the same on the screen, in order to provide a simple reply.

In operation 2350, the electronic device may select a recommended response according to a user input (e.g., a touch input). For example, the electronic device may select a recommended response using touch coordinates.

In operation 2360, the electronic device may change a property of the selected recommended response according to a user input (e.g., a touch input). For example, the electronic device may change (modify or process) the selected recommended response in proportion to a pressure input.

According to an embodiment, the property of the recommended response may be variously defined depending on the form and the type of a recommended response. For example, if the recommended response is in the form of text, the properties may be the size, color, font, thickness, tilt, underline, and/or an animation effect associated with text and the like. For example, if the recommended response is in the form of an emoticon, the properties may be the size, color, an animation effect, and/or replacement associated with the emoticon and the like. The replacement of the emoticon may indicate changing the selected emoticon to another emoticon belonging to a category associated with the same expression as that of the selected emoticon.

In operation 2370, the electronic device may display the recommended response of which the property has been changed on the screen. For example, the electronic device may update the screen as the selected recommended response is changed.

In operation 2380, the electronic device may transmit the recommended response including the changed property to the sender of the message.

According to various embodiments, a control method of an electronic device may include: receiving a message; when the pressure of an input for a response message to the received message is detected from a touch screen of the electronic device, determining an execution mode for generating the response message using at least one of the pressure strength or the duration of the input; and providing, to the touch screen, a user interface for writing the response message according to the determined execution mode.

According to various embodiments, the operation of providing the user interface for writing the response message to the touch screen may include: when the input is a pressure input of a first strength, displaying a response message to be included in the response message on the touch screen using information related to the received message; and when the pressure of the input is detected from the touch screen, changing a property of the response message on the basis of the pressure of the input to the touch screen.

According to various embodiments, the response message may include at least one of text, an emoticon, an image, a video, or an avatar.

According to various embodiments, the property of the response message may include at least one of a size, a color, or a form.

According to various embodiments, the operation of changing the property of the response message may include: increasing or decreasing the strength of color of the response message at a designated ratio or scaling up or down the size of the response message at a designated ratio according to the strength of the pressure of the input to the response message.

According to various embodiments, when a third input to the response message is detected, the method may further include an operation of displaying the response message and a response message corresponding to the response message on the touch screen.

According to various embodiments, the control method of the electronic device may include: receiving a message; displaying at least one response message to the received message on a touch display of the electronic device; receiving at least one input via the touch screen display; and changing the at least one response message on the basis of at least one of the pressure or the duration of the pressure of the received input.

According to various embodiments, the control method may further include: identifying data which is related to the received message and is stored in the electronic device; and generating the at least one response message on the basis of a result of the identification.

According to various embodiments, the control method may further include: receiving an input for selecting at least one response; and transmitting the at least one changed response message.

The term “module” as used herein may include a unit consisting of hardware, software, or firmware, and may, for example, be used interchangeably with the term “logic”, “logical block”, “component”, “circuit”, or the like. The “module” may be an integrated component, or a minimum unit for performing one or more functions or a part thereof. The “module” may be mechanically or electronically implemented and may include, for example, an Application-Specific Integrated Circuit (ASIC) chip, a Field-Programmable Gate Arrays (FPGA), or a programmable-logic device, which has been known or are to be developed in the future, for performing certain operations. At least some of devices (e.g., modules or functions thereof) or methods (e.g., operations) according to various embodiments may be implemented by an instruction which is stored a computer-readable storage medium (e.g., the memory 130) in the form of a program module. The instruction, when executed by a processor (e.g., the processor 120), may cause the one or more processors to execute the function corresponding to the instruction. The computer-readable storage medium may include a hard disk, a floppy disk, a magnetic medium (e.g., a magnetic tape), an Optical Media (e.g., CD-ROM, DVD), a Magneto-Optical Media (e.g., a floptical disk), an inner memory, etc. The instruction may include a code made by a complier or a code that can be executed by an interpreter. The programming module according to the disclosure may include one or more of the aforementioned elements or may further include other additional elements, or some of the aforementioned elements may be omitted. Operations performed by a module, a programming module, or other elements according to various embodiments may be executed sequentially, in parallel, repeatedly, or in a heuristic manner. At least some operations may be executed according to another sequence, may be omitted, or may further include other operations.

1. An electronic device, comprising:
a touch screen display;
a pressure sensor configured to detect a pressure on the touch screen display;
a wireless communication circuit configured to transmit and receive a radio signal;
at least one processor electrically connected to the touch screen display, the pressure sensor, and the wireless communication circuit; and
a memory electrically connected to the processor,
wherein the memory stores instructions, and when the instructions are executed, the instructions enable the processor to perform: displaying, on the touch screen display, at least one response message to a message received via the wireless communication circuit;
receiving at least one input via the touch screen display; and
changing the at least one response message based on at least one of a pressure strength or a duration of the received input.

2. The electronic device of claim 1, wherein the instructions are configured to enable the processor to perform: identifying data which is related to the received message and is stored in the memory; and
generating at least one response message based on a result of identification.

3. The electronic device of claim 1, wherein the instructions are configured to enable the processor to further receive an input for selecting the at least one response.

4. The electronic device of claim 1, wherein the instructions are configured to enable the processor to transmit the at least one changed response message.

5. The electronic device of claim 1, wherein the at least one response message comprises at least one of text, an emoticon, an image, a video, or an avatar.

6. The electronic device of claim 1, wherein the instructions are configured to enable the processor to change a color of the response message based on the pressure strength of the input to the response message.

7. The electronic device of claim 1, wherein the instructions are configured to enable the processor to perform scaling up or down a size of the response message based on the pressure strength of the input to the response message, and to display the scaled response message.

8. The electronic device of claim 1, wherein the instructions are configured to enable the processor to display the response message and at least one additional response message corresponding to the response message on the touch screen when an input to the response message is detected.

9. The electronic device of claim 1, wherein, when the response message comprises a plurality of emoticons, the instructions are configured to enable the processor to display a first emoticon at a designated location of the touch screen, to display simplified text corresponding to the first emoticon, or to display recommend text corresponding to the first emoticon, according to a pressure strength of an input to the first emoticon when the input to the first emoticon among the plurality of emoticons is detected.

10. The electronic device of claim 1, wherein, when a response message to be included in the response message comprises a plurality of emoticons, the instructions are configured to enable the processor to perform scaling up or down a first emoticon according to a pressure strength of an input to the first emoticon when the input to the first emoticon among the plurality of emoticons is detected, and to display the scaled first emoticon at a designated location of the touch screen.

11. The electronic device of claim 1, wherein the instructions are configured to enable the processor to perform: generating one or more recommended response messages to the received message; extracting at least one keyword associated with the recommended response messages; and determining the keyword to be the response message.

12. The electronic device of claim 1, wherein the instructions are configured to enable the processor to perform: generating one or more recommended response messages to the received message; extracting at least one keyword associated with the recommended response messages; detecting at least one emoticon corresponding to the keyword; and determining the emoticon to be the response message.

13. The electronic device of claim 1, wherein the instructions are configured to enable the processor to perform: displaying the response message on the touch screen display using information related to the received message when a pressure input of a first strength is detected from the touch screen display using the pressure sensor; and
changing a property of the response message based on a pressure strength of the input to the touch screen display,
wherein the property of the response message comprises at least one of a size, a color, or a form.

14. The electronic device of claim 1, wherein the instructions are configured to enable the processor to perform: additionally displaying at least one of a user interface for changing at least one property corresponding to the response message or a user interface for additionally displaying a designated number of response messages corresponding to the response message according to a pressure strength of the input to the response message; and
changing a property according to an input to the user interface for changing the at least one property,
wherein the user interface for changing the at least one property comprises at least one of a user interface for changing a color of the response message and a user interface for changing a size of the response message.

15. A control method of an electronic device, the method comprising:
receiving a message;
displaying at least one response message to the received message on a touch screen display of the electronic device;
receiving at least one input via the touch screen display; and
changing the at least one response message based on at least one of a pressure strength or a duration of the received input.
